(19) United States
(12) Patent Application Publication
(10) Pub. No.: US 2023/0269611 A1
(43) Pub. Date: Aug. 24, 2023

(54) CROSS LINK INTERFERENCE MEASUREMENT CONFIGURATION

(71) Applicant: QUALCOMM Incorporated, San Diego, CA (US)

(72) Inventors: Yuwei REN, Beijing (CN); Huilin XU, Temecula, CA (US)

(21) Appl. No.: 18/004,014

(22) PCT Filed: Jul. 31, 2020
(86) PCT No.: PCT/CN2020/106251

§ 371 Date: Dec. 30, 2022

(51) Int. Cl. H04W 24/08; H04W 24/10; H04B 17/345

(52) U.S. Cl. CPC H04W 24/08; H04W 24/10; H04B 17/345

(57) ABSTRACT

Aspects relate to a configuring cross link interference (CLI) measurements. In some examples, a base station may configure a first user equipment (UE) to relay a CLI configuration to a second UE. In response, the second UE may send a CLI measurement report to the first UE whereby the first UE relays the CLI measurement report to the base station. In some examples, a base station may configure a first UE to schedule CLI measurements. In this case, the first UE may generate a CLI configuration for a second UE and send the CLI configuration to the second UE. The second UE may then send a CLI measurement report to the first UE. In some examples, a base station may send a CLI configuration to a UE and the UE may send a CLI measurement report to another UE that relays the CLI measurement report to the base station.

### TECHNICAL FIELD

The technology discussed below relates generally to wireless communication and, more particularly, to configuring cross link interference (CLI) measurements.

### INTRODUCTION

Next-generation wireless communication systems (e.g., 5GS) may include a 5G core network and a 5G radio access network (RAN), such as a New Radio (NR)-RAN. The NR-RAN supports communication via one or more cells. For example, a wireless communication device such as a user equipment (UE) may access a first cell of a first base station (BS) such as a gNB and/or access a second cell of a second base station.

A base station may schedule access to a cell to support access by multiple UEs. For example, a base station may allocate different resources (e.g., time domain and frequency domain resources) for different UEs operating within a cell of the base station. In some cases, the signaling between a base station and UE may be subject to interference. For example, when a first UE transmits an uplink signal at substantially the same time as a nearby second UE receives a downlink signal, transmission of the uplink signal by the first UE may interfere with the reception of the downlink signal by the second UE. This type of interference may be referred to as cross link interference (CLI), or more specifically, UE-to-UE CLI.

As the demand for mobile access continues to increase, research and development continue to advance communication technologies, including technologies for enhancing mobile communication within a wireless communication network in particular, not only to meet the growing demand for mobile access, but to advance and enhance user experience associated with mobile communication.

### BRIEF SUMMARY OF SOME EXAMPLES

The following presents a summary of one or more aspects of the present disclosure, in order to provide a basic understanding of such aspects. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in a form as a prelude to the more detailed description that is presented later.

Various aspects of the disclosure relate to configuring cross link interference (CLI) measurements. For example, a base station may configure a UE to conduct a CLI measurement on one or more resources, generate a CLI measurement report based on the CLI measurement, and send the CLI measurement report to the base station. As another example, a first UE may configure a second UE to conduct a CLI measurement on one or more resources, generate a CLI measurement report based on the CLI measurement, and send the CLI measurement report to the first UE.

In some examples, a base station may configure a first UE to relay a CLI configuration to a second UE (e.g., via a sidelink channel). In response, the second UE may send a CLI measurement report to the first UE (e.g., via a sidelink channel) whereby the first UE relays the CLI measurement report to the base station. This approach may be used, for example, in the event the second UE is beyond the coverage of the base station.

In some examples, a base station may configure a first UE to schedule CLI measurements. In this case, the first UE may generate a CLI configuration for a second UE and send the CLI configuration to the second UE (e.g., via a sidelink channel). The second UE may then send a CLI measurement report to the first UE (e.g., via a sidelink channel). This approach may be used, for example, in the event the second UE is beyond the coverage of the base station.

In some examples, a base station may be able to reach a UE on a downlink channel, but the UE might not be able to reach the base station on an uplink channel. In this case, the base station may generate a CLI configuration for the UE and send the CLI configuration to the UE (e.g., via a downlink channel). However, the UE may send a CLI measurement report to another UE (e.g., via a sidelink channel) that has uplink connectivity to the base station. The other UE may then relay the CLI measurement report to the base station.

In some examples, a method of wireless communication at a first user equipment may include receiving a cross link interference (CLI) configuration from a base station, determining that the CLI configuration is for a second UE, and transmitting the CLI configuration to the second UE after determining that the CLI configuration is for the second UE.

In some examples, a first user equipment may include a transceiver, a memory, and a processor communicatively coupled to the transceiver and the memory. The processor and the memory may be configured to receive a cross link interference (CLI) configuration from a base station via the transceiver, determine that the CLI configuration is for a second UE, and transmit the CLI configuration to the second UE after determining that the CLI configuration is for the second UE.

In some examples, a first user equipment may include means for receiving a cross link interference (CLI) configuration from a base station, means for determining that the CLI configuration is for a second UE, and means for transmitting the CLI configuration to the second UE after determining that the CLI configuration is for the second UE.

In some examples, an article of manufacture for use by a first user equipment includes a computer-readable medium having stored therein instructions executable by one or more processors of the first user equipment to receive a cross link interference (CLI) configuration from a base station, determine that the CLI configuration is for a second UE, and transmit the CLI configuration to the second UE after determining that the CLI configuration is for the second UE.

One or more of the following features may be applicable to any of the method, the apparatuses, and the computer-readable medium of the preceding paragraphs. Transmitting the CLI configuration may include transmitting the CLI configuration via a sidelink channel to the second UE. The CLI configuration may specify at least one CLI resource for the second UE to measure for a CLI measurement report. The at least one CLI resource may include a resource allocated to the first UE for an uplink transmission to the base station and/or a resource allocated to a third UE for an uplink transmission to the base station. A CLI measurement report may be received from the second UE after transmitting the CLI configuration to the second UE, a determination may be made that that the CLI measurement report is for the base station, and the CLI measurement report may be transmitted to the base station after determining that the CLI measurement report is for the base station. The CLI measurement report may indicate a signal measurement by the second UE on at least one CLI resource specified by the CLI configuration.

In some examples, a method of wireless communication at a first user equipment may include receiving a cross link interference (CLI) configuration specifying at least one CLI resource, measuring signals on the at least one CLI resource, generating a CLI measurement report from the measuring of the signals on the at least one CLI resource, and transmitting the CLI measurement report to a second UE.

In some examples, a first user equipment may include a transceiver, a memory, and a processor communicatively coupled to the transceiver and the memory. The processor and the memory may be configured to receive a cross link interference (CLI) configuration specifying at least one CLI resource, measure signals on the at least one CLI resource, generate a CLI measurement report from the measuring of the signals on the at least one CLI resource, and transmit the CLI measurement report to a second UE via the transceiver.

In some examples, a first user equipment may include means for receiving a cross link interference (CLI) configuration specifying at least one CLI resource, means for measuring signals on the at least one CLI resource, means for generating a CLI measurement report from the measuring of the signals on the at least one CLI resource, and means for transmitting the CLI measurement report to a second UE.

In some examples, an article of manufacture for use by a first user equipment includes a computer-readable medium having stored therein instructions executable by one or more processors of the first user equipment to receive a cross link interference (CLI) configuration specifying at least one CLI resource, measure signals on the at least one CLI resource, generate a CLI measurement report from the measuring of the signals on the at least one CLI resource, and transmit the CLI measurement report to a second UE.

One or more of the following features may be applicable to any of the method, the apparatuses, and the computer-readable medium of the preceding paragraphs. Transmitting the CLI configuration may include transmitting the CLI configuration via a sidelink channel to the second UE. Receiving the CLI configuration may include receiving the CLI configuration from a base station. The at least one CLI resource may include a resource allocated by the base station for an uplink transmission by the second UE or a third UE to the base station. A determination may be made that the first UE cannot communicate with the base station via an uplink channel. Transmitting the CLI measurement report may include transmitting the CLI measurement report via a sidelink channel to the second UE after determining that the first UE cannot communicate with the base station via the uplink channel. Receiving the CLI configuration may include receiving the CLI configuration from the second UE. The CLI configuration may indicate that the first UE is to send a CLI measurement report to a base station or the second UE. The CLI configuration may indicate that the at least one CLI resource is an uplink resource or a sidelink resource.

In some examples, a method of wireless communication at a first user equipment may include receiving a message from a base station. In some aspects, the message may configure the first UE to schedule cross link interference (CLI) measurements. The method may also include generating a first CLI configuration for a second UE after receiving the message, transmitting the first CLI configuration to the second UE, and receiving a CLI measurement report from the second UE after transmitting the first CLI configuration to the second UE.

In some examples, a first user equipment may include a transceiver, a memory, and a processor communicatively coupled to the transceiver and the memory. The processor and the memory may be configured to receive a message from a base station via the transceiver. In some aspects, the message may configure the first UE to schedule cross link interference (CLI) measurements. The processor and the memory may also be configured to generate a first CLI configuration for a second UE after receiving the message, transmit the first CLI configuration to the second UE, and receive a CLI measurement report from the second UE after transmitting the first CLI configuration to the second UE.

In some examples, a first user equipment may include means for receiving a message from a base station. In some aspects, the message may configure the first UE to schedule cross link interference (CLI) measurements. The first user equipment may also include means for generating a first CLI configuration for a second UE after receiving the message, means for transmitting the first CLI configuration to the second UE, and means for receiving a CLI measurement report from the second UE after transmitting the first CLI configuration to the second UE.

In some examples, an article of manufacture for use by a first user equipment includes a computer-readable medium having stored therein instructions executable by one or more processors of the first user equipment to receive a message from a base station. In some aspects, the message may configure the first UE to schedule cross link interference (CLI) measurements. The computer-readable medium may also have stored therein instructions executable by one or more processors of the first user equipment to generate a first CLI configuration for a second UE after receiving the message, transmit the first CLI configuration to the second UE, and receive a CLI measurement report from the second UE after transmitting the first CLI configuration to the second UE.

One or more of the following features may be applicable to any of the method, the apparatuses, and the computer-readable medium of the preceding paragraphs. Transmitting the first CLI configuration may include transmitting the first CLI configuration via a sidelink channel to the second UE. Receiving the CLI measurement report may include receiving the CLI measurement report via the sidelink channel from the second UE. A second CLI configuration may be received from the base station. The second CLI configuration may specify at least one CLI resource for the first UE to measure. Generating the first CLI configuration may include selecting a first resource of the at least one CLI resource for the second UE to measure and including an indication of the first resource in the first CLI configuration. The at least one CLI resource may include a resource allocated to a third UE for an uplink transmission to the base station. Generating the first CLI configuration may include selecting a sidelink resource for the second UE to measure and including an indication of the sidelink resource in the first CLI configuration. The sidelink resource may include a resource allocated to a third UE for a sidelink transmission. Generating the first CLI configuration may include identifying interference on a first set of resources of a plurality of resources, selecting a sidelink resource for the second UE to measure from a second set of resources of the plurality of resources, and including an indication of the sidelink resource in the first CLI configuration. The second set of resources may be different from the first set of resources.

In some examples, a method of wireless communication at a base station may include generating a cross link interference (CLI) configuration for a first UE, transmitting the CLI configuration, and receiving a CLI measurement report generated by the first UE from a second UE after transmitting the CLI configuration.

In some examples, a base station may include a transceiver, a memory, and a processor communicatively coupled to the transceiver and the memory. The processor and the memory may be configured to generate a cross link interference (CLI) configuration for a first UE, transmit the CLI configuration via the transceiver, and receive a CLI measurement report generated by the first UE from a second UE after transmitting the CLI configuration.

In some examples, a base station may include means for generating a cross link interference (CLI) configuration for a first UE, means for transmitting the CLI configuration, and means for receiving a CLI measurement report generated by the first UE from a second UE after transmitting the CLI configuration.

In some examples, an article of manufacture for use by a base station includes a computer-readable medium having stored therein instructions executable by one or more processors of the base station to generate a cross link interference (CLI) configuration for a first UE, transmit the CLI configuration, and receive a CLI measurement report generated by the first UE from a second UE after transmitting the CLI configuration.

One or more of the following features may be applicable to any of the method, the apparatuses, and the computer-readable medium of the preceding paragraphs. Transmitting the CLI configuration may include transmitting the CLI configuration to the first UE via a connection to the first UE. Transmitting the CLI configuration may include transmitting the CLI configuration to the second UE via a connection to the second UE. Transmitting the CLI configuration may include transmitting a message indicating that the second UE is to forward the CLI configuration to the first UE. An election may be made to use the first UE to relay the CLI configuration to the second UE after determining that the base station cannot communicate with the second UE. The CLI configuration may be transmitted to the second UE via a downlink channel after determining that the base station cannot communicate with the first UE via another downlink channel.

In some examples, a method of wireless communication at a base station may include electing to use a first UE to schedule cross link interference (CLI) measurements, generating a message that configures the first UE to schedule the CLI measurements, and transmitting the message to the first UE.

In some examples, a base station may include a transceiver, a memory, and a processor communicatively coupled to the transceiver and the memory. The processor and the memory may be configured to elect to use a first UE to schedule cross link interference (CLI) measurements, generate a message that configures the first UE to schedule the CLI measurements, and transmit the message to the first UE via the transceiver.

In some examples, a base station may include means for electing to use a first UE to schedule cross link interference (CLI) measurements, means for generating a message that configures the first UE to schedule the CLI measurements, and means for transmitting the message to the first UE.

In some examples, an article of manufacture for use by a base station includes a computer-readable medium having stored therein instructions executable by one or more processors of the base station to elect to use a first UE to schedule cross link interference (CLI) measurements, generate a message that configures the first UE to schedule the CLI measurements, and transmit the message to the first UE.

One or more of the following features may be applicable to any of the method, the apparatuses, and the computer-readable medium of the preceding paragraphs. The message may configure the first UE to schedule CLI measurements on at least one uplink resource. The message may configure the first UE to schedule CLI measurements on at least one sidelink resource. Generating the message that configures the first UE to schedule CLI measurements may be triggered by the determining that the base station cannot communicate with the first UE. Generating the message that configures the first UE to schedule CLI measurements may be triggered by the determining that the base station cannot communicate with the first UE and by the determining that the second UE has the sidelink connection to the first UE. Electing to use the first UE to schedule the CLI measurements may be triggered by the electing to use CLI measurements to determine UE positioning. An election may be made to use a sidelink resource for the CLI measurements after determining that the Uu CLI resource is not currently configured. Electing to use the first UE to schedule the CLI measurements may be triggered by determining that Uu CLI resources are to be used for CLI measurements.

These and other aspects of the disclosure will become more fully understood upon a review of the detailed description, which follows. Other aspects, features, and embodiments of the present disclosure will become apparent to those of ordinary skill in the art, upon reviewing the following description of specific, example embodiments of the present disclosure in conjunction with the accompanying figures. While features of the present disclosure may be discussed relative to certain embodiments and figures below, all embodiments of the present disclosure can include one or more of the advantageous features discussed herein. In other words, while one or more embodiments may be discussed as having certain advantageous features, one or more of such features may also be used in accordance with the various embodiments of the disclosure discussed herein. In similar fashion, while example embodiments may be discussed below as device, system, or method embodiments it should be understood that such example embodiments can be implemented in various devices, systems, and methods.

### BRIEF DESCRIPTION OF THE DRAWINGS

FIG. 1 is a schematic illustration of a wireless communication system according to some aspects.

FIG. 2 is a conceptual illustration of an example of a radio access network according to some aspects.

FIG. 3 is a schematic illustration of wireless resources in an air interface utilizing orthogonal frequency divisional multiplexing (OFDM) according to some aspects.

FIG. 4 is a conceptual illustration of an example of a wireless communication network with user equipments (UEs) in an intra-cell deployment according to some aspects.

FIG. 5 is a conceptual illustration of an example of a wireless communication network with UEs in an inter-cell, homogeneous deployment according to some aspects.

FIG. 6 is a conceptual illustration of example resource allocations for UEs according to some aspects.

FIG. 7 is a conceptual illustration of an example of a wireless communication network with UEs in an intra-cell deployment according to some aspects.

FIG. 8 is a conceptual illustration of an example of a wireless communication network with UEs in an intra-cell deployment according to some aspects.

FIG. 9 is a conceptual illustration of an example of a wireless communication network with UEs in an intra-cell deployment according to some aspects.

FIG. 10 is a conceptual illustration of an example of a wireless communication network where a UE relays CLI information according to some aspects.

FIG. 11 is a conceptual illustration of an example of a wireless communication network where UEs communicate via sidelink signaling according to some aspects.

FIG. 12 is a conceptual illustration of an example of a wireless communication network where sidelink signaling is used to determine UE positioning according to some aspects.

FIG. 13 is a conceptual illustration of an example of a wireless communication network where a UE schedules a CLI measurement according to some aspects.

FIG. 14 is a block diagram illustrating an example of a hardware implementation for a UE employing a processing system according to some aspects.

FIG. 15 is a flow chart of an example CLI measurement method according to some aspects.

FIG. 16 is a flow chart of an example CLI measurement method according to some aspects.

FIG. 17 is a flow chart of an example CLI measurement method according to some aspects.

FIG. 18 is a block diagram illustrating an example of a hardware implementation for a base station employing a processing system according to some aspects.

FIG. 19 is a flow chart of an example CLI measurement method according to some aspects.

FIG. 20 is a flow chart of an example CLI measurement method according to some aspects.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

While aspects and embodiments are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, embodiments and/or uses may come about via integrated chip embodiments and other non-module-component based devices (e.g., end-user devices, vehicles, communication devices, computing devices, industrial equipment, retail/purchasing devices, medical devices, artificial intelligence-enabled devices, etc.). While some examples may or may not be specifically directed to use cases or applications, a wide assortment of applicability of described innovations may occur. Implementations may range a spectrum from chip-level or modular components to non-modular, non-chip-level implementations and further to aggregate, distributed, or OEM devices or systems incorporating one or more aspects of the described innovations. In some practical settings, devices incorporating described aspects and features may also necessarily include additional components and features for implementation and practice of claimed and described embodiments. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes and constitution.

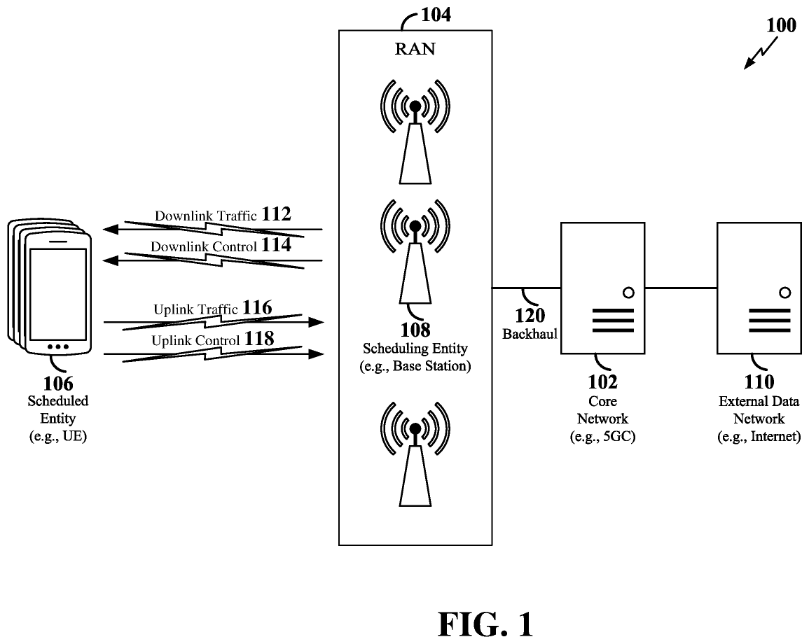

The various concepts presented throughout this disclosure may be implemented across a broad variety of telecommunication systems, network architectures, and communication standards. Referring now to FIG. 1, as an illustrative example without limitation, various aspects of the present disclosure are illustrated with reference to a wireless communication system 100. The wireless communication system 100 includes three interacting domains: a core network 102, a radio access network (RAN) 104, and at least one scheduled entity 106. The at least one scheduled entity 106 may be referred to as a user equipment (UE) 106 in the discussion that follows. The RAN 104 includes at least one scheduling entity 108. The at least one scheduling entity 108 may be referred to as a base station (BS) 108 in the discussion that follows. By virtue of the wireless communication system 100, the UE 106 may be enabled to carry out data communication with an external data network 110, such as (but not limited to) the Internet.

The RAN 104 may implement any suitable wireless communication technology or technologies to provide radio access to the UE 106. As one example, the RAN 104 may operate according to 3rd Generation Partnership Project (3GPP) New Radio (NR) specifications, often referred to as 5G. As another example, the RAN 104 may operate under a hybrid of 5G NR and Evolved Universal Terrestrial Radio Access Network (eUTRAN) standards, often referred to as LTE. The 3GPP refers to this hybrid RAN as a next-generation RAN, or NG-RAN. Of course, many other examples may be utilized within the scope of the present disclosure.

As illustrated, the RAN 104 includes a plurality of base stations 108. Broadly, a base station is a network element in a radio access network responsible for radio transmission and reception in one or more cells to or from a UE. In different technologies, standards, or contexts, a base station may variously be referred to by those skilled in the art as a base transceiver station (BTS), a radio base station, a radio transceiver, a transceiver function, a basic service set (BSS), an extended service set (ESS), an access point (AP), a Node B (NB), an eNode B (eNB), a gNode B (gNB), or some other suitable terminology.

The radio access network 104 is further illustrated supporting wireless communication for multiple mobile apparatuses. A mobile apparatus may be referred to as user equipment (UE) in 3GPP standards, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. A UE may be an apparatus that provides a user with access to network services.

Within the present document, a “mobile” apparatus need not necessarily have a capability to move, and may be stationary. The term mobile apparatus or mobile device broadly refers to a diverse array of devices and technologies. UEs may include a number of hardware structural components sized, shaped, and arranged to help in communication; such components can include antennas, antenna arrays, RF chains, amplifiers, one or more processors, etc. electrically coupled to each other. For example, some non-limiting examples of a mobile apparatus include a mobile, a cellular (cell) phone, a smart phone, a session initiation protocol (SIP) phone, a laptop, a personal computer (PC), a notebook, a netbook, a smartbook, a tablet, a personal digital assistant (PDA), and a broad array of embedded systems, e.g., corresponding to an “Internet of Things” (IoT). A mobile apparatus may additionally be an automotive or other transportation vehicle, a remote sensor or actuator, a robot or robotics device, a satellite radio, a global positioning system (GPS) device, an object tracking device, a drone, a multi-copter, a quad-copter, a remote control device, a consumer and/or wearable device, such as eyewear, a wearable camera, a virtual reality device, a smart watch, a health or fitness tracker, a digital audio player (e.g., MP3 player), a camera, a game console, etc. A mobile apparatus may additionally be a digital home or smart home device such as a home audio, video, and/or multimedia device, an appliance, a vending machine, intelligent lighting, a home security system, a smart meter, etc. A mobile apparatus may additionally be a smart energy device, a security device, a solar panel or solar array, a municipal infrastructure device controlling electric power (e.g., a smart grid), lighting, water, etc.; an industrial automation and enterprise device; a logistics controller; agricultural equipment; military defense equipment, vehicles, aircraft, ships, and weaponry, etc. Still further, a mobile apparatus may provide for connected medicine or telemedicine support, i.e., health care at a distance. Telehealth devices may include telehealth monitoring devices and telehealth administration devices, whose communication may be given preferential treatment or prioritized access over other types of information, e.g., in terms of prioritized access for transport of critical service data, and/or relevant QoS for transport of critical service data.

Wireless communication between a RAN 104 and a UE 106 may be described as utilizing an air interface. Transmissions over the air interface from a base station (e.g., base station 108) to one or more UEs (e.g., UE 106) may be referred to as downlink (DL) transmission. In accordance with certain aspects of the present disclosure, the term downlink may refer to a point-to-multipoint transmission originating at a scheduling entity (described further below; e.g., base station 108). Another way to describe this scheme may be to use the term broadcast channel multiplexing. Transmissions from a UE (e.g., UE 106) to a base station (e.g., base station 108) may be referred to as uplink (UL) transmissions. In accordance with further aspects of the present disclosure, the term uplink may refer to a point-to-point transmission originating at a scheduled entity (described further below; e.g., UE 106).

In some examples, access to the air interface may be scheduled, wherein a scheduling entity (e.g., a base station 108) allocates resources for communication among some or all devices and equipment within its service area or cell. Within the present disclosure, as discussed further below, the scheduling entity may be responsible for scheduling, assigning, reconfiguring, and releasing resources for one or more scheduled entities. That is, for scheduled communication, UEs 106, which may be scheduled entities, may utilize resources allocated by the scheduling entity 108.

Base stations 108 are not the only entities that may function as scheduling entities. That is, in some examples, a UE may function as a scheduling entity, scheduling resources for one or more scheduled entities (e.g., one or more other UEs).

As illustrated in FIG. 1, a scheduling entity 108 may broadcast downlink traffic 112 to one or more scheduled entities 106. Broadly, the scheduling entity 108 is a node or device responsible for scheduling traffic in a wireless communication network, including the downlink traffic 112 and, in some examples, uplink traffic 116 from one or more scheduled entities 106 to the scheduling entity 108. On the other hand, the scheduled entity 106 is a node or device that receives downlink control information 114, including but not limited to scheduling information (e.g., a grant), synchronization or timing information, or other control information from another entity in the wireless communication network such as the scheduling entity 108.

In addition, the uplink and/or downlink control information and/or traffic information may be time-divided into frames, subframes, slots, and/or symbols. As used herein, a symbol may refer to a unit of time that, in an orthogonal frequency division multiplexed (OFDM) waveform, carries one resource element (RE) per sub-carrier. A slot may carry 7 or 14 OFDM symbols. A subframe may refer to a duration of lms. Multiple subframes or slots may be grouped together to form a single frame or radio frame. Of course, these definitions are not required, and any suitable scheme for organizing waveforms may be utilized, and various time divisions of the waveform may have any suitable duration.

In general, base stations 108 may include a backhaul interface for communication with a backhaul portion 120 of the wireless communication system. The backhaul 120 may provide a link between a base station 108 and the core network 102. Further, in some examples, a backhaul network may provide interconnection between the respective base stations 108. Various types of backhaul interfaces may be employed, such as a direct physical connection, a virtual network, or the like using any suitable transport network.

The core network 102 may be a part of the wireless communication system 100, and may be independent of the radio access technology used in the RAN 104. In some examples, the core network 102 may be configured according to 5G standards (e.g., 5GC). In other examples, the core network 102 may be configured according to a 4G evolved packet core (EPC), or any other suitable standard or configuration.

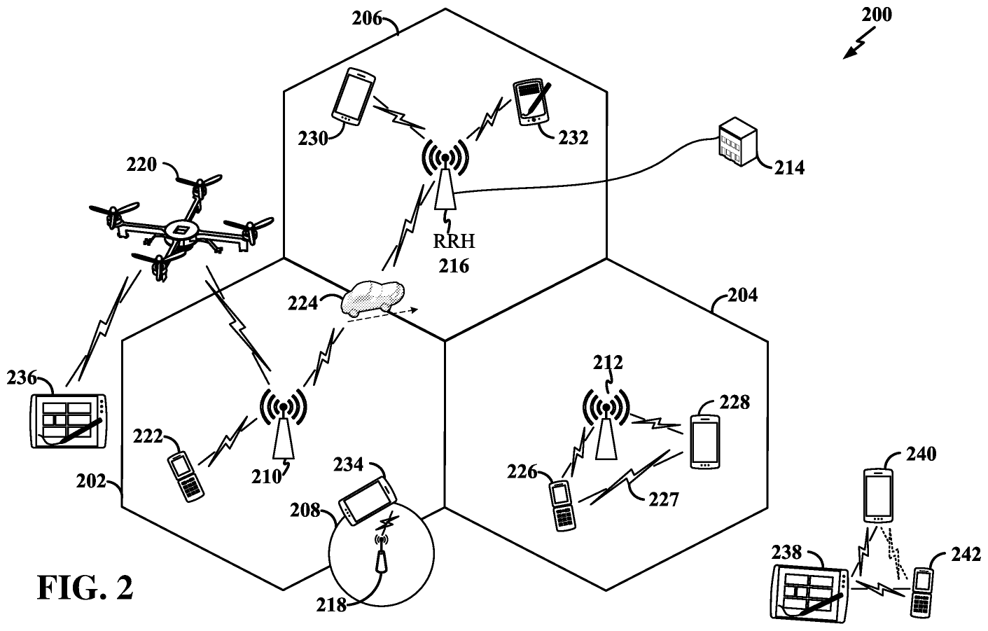

Referring now to FIG. 2, by way of example and without limitation, a schematic illustration of a RAN 200 is provided. In some examples, the RAN 200 may be the same as the RAN 104 described above and illustrated in FIG. 1. The geographic area covered by the RAN 200 may be divided into cellular regions (cells) that can be uniquely identified by a user equipment (UE) based on an identification broadcasted from one access point or base station. FIG. 2 illustrates macrocells 202, 204, and 206, and a small cell 208, each of which may include one or more sectors (not shown). A sector is a sub-area of a cell. All sectors within one cell are served by the same base station. A radio link within a sector can be identified by a single logical identification belonging to that sector. In a cell that is divided into sectors, the multiple sectors within a cell can be formed by groups of antennas with each antenna responsible for communication with UEs in a portion of the cell.

Various base station arrangements can be utilized. For example, in FIG. 2, two base stations 210 and 212 are shown in cells 202 and 204; and a third base station 214 is shown controlling a remote radio head (RRH) 216 in cell 206. That is, a base station can have an integrated antenna or can be connected to an antenna or RRH by feeder cables. In the illustrated example, the cells 202, 204, and 206 may be referred to as macrocells, as the base stations 210, 212, and 214 support cells having a large size. Further, a base station 218 is shown in the small cell 208 (e.g., a microcell, picocell, femtocell, home base station, home Node B, home eNode B, etc.) which may overlap with one or more macrocells. In this example, the cell 208 may be referred to as a small cell, as the base station 218 supports a cell having a relatively small size. Cell sizing can be done according to system design as well as component constraints.

It is to be understood that the radio access network 200 may include any number of wireless base stations and cells. Further, a relay node may be deployed to extend the size or coverage area of a given cell. The base stations 210, 212, 214, 218 provide wireless access points to a core network for any number of mobile apparatuses. In some examples, the base stations 210, 212, 214, and/or 218 may be the same as the base station/scheduling entity 108 described above and illustrated in FIG. 1.

Within the RAN 200, the cells may include UEs that may be in communication with one or more sectors of each cell. Further, each base station 210, 212, 214, and 218 may be configured to provide an access point to a core network (e.g., as illustrated in FIG. 1) for all the UEs in the respective cells. For example, UEs 222 and 224 may be in communication with base station 210; UEs 226 and 228 may be in communication with base station 212; UEs 230 and 232 may be in communication with base station 214 by way of RRH 216; and UE 234 may be in communication with base station 218. In some examples, the UEs 222, 224, 226, 228, 230, 232, 234, 238, 240, and/or 242 may be the same as the UE/scheduled entity 106 described above and illustrated in FIG. 1.

In some examples, an unmanned aerial vehicle (UAV) 220, which may be a drone or quadcopter, can be a mobile network node and may be configured to function as a UE. For example, the UAV 220 may operate within cell 202 by communicating with base station 210. In some examples, a UAV 220 may be configured to function as a BS. That is, in some examples, a cell may not necessarily be stationary, and the geographic area of the cell may move according to the location of a mobile base station such as a UAV 220.

In a further aspect of the RAN 200, sidelink signals may be used between UEs without necessarily relying on scheduling or control information from a base station. For example, two or more UEs (e.g., UEs 226 and 228) may communicate with each other using peer to peer (P2P) or sidelink signals 227 without relaying that communication through a base station (e.g., base station 212). In a further example, UE 238 is illustrated communicating with UEs 240 and 242. Here, the UE 238 may function as a scheduling entity or a primary sidelink device, and UEs 240 and 242 may function as a scheduled entity or a non-primary (e.g., secondary) sidelink device. In still another example, a UE may function as a scheduling entity in a device-to-device (D2D), peer-to-peer (P2P), or vehicle-to-vehicle (V2V) network, and/or in a mesh network. In a mesh network example, UEs 240 and 242 may optionally communicate directly with one another in addition to communicating with the UE 238 (e.g., functioning as a scheduling entity). Thus, in a wireless communication system with scheduled access to time-frequency resources and having a cellular configuration, a P2P configuration, or a mesh configuration, a scheduling entity and one or more scheduled entities may communicate utilizing the scheduled resources. In some examples, the sidelink signals 227 include sidelink traffic (e.g., a physical sidelink shared channel) and sidelink control (e.g., a physical sidelink control channel).

In some examples, two or more UEs (e.g., UEs 226 and 228) within the coverage area of a serving base station 212 may communicate with both the base station 212 using cellular signals and with each other using direct link signals (e.g., sidelink signals 227) without relaying that communication through the base station. In an example of a V2X network within the coverage area of the base station 212, the base station 212 and/or one or both of the UEs 226 and 228 may function as scheduling entities to schedule sidelink communication between UEs 226 and 228.

Two primary technologies that may be used by V2X networks include dedicated short range communication (DSRC) based on IEEE 802.11p standards and cellular V2X based on LTE and/or 5G (New Radio) standards. A V2X network can connect vehicles to each other (vehicle-to-vehicle (V2V)), to roadway infrastructure (vehicle-to-infrastructure (V2I)), to pedestrians/cyclists (vehicle-to-pedestrian (V2P) (e.g., mobile devices, such as user equipment (UE) and/or wearables of pedestrians/cyclists)), and/or to the network (vehicle-to-network (V2N)). Various aspects of the present disclosure may relate to New Radio (NR) cellular V2X networks, referred to herein as V2X networks, for simplicity. However, it should be understood that the concepts disclosed herein may not be limited to a particular V2X standard or may be directed to sidelink networks other than V2X networks.

The sidelink signals 227 between UEs 226 and 228 or between UEs 238, 240, and 242 may be sent over a proximity service (ProSe) PC5 interface. ProSe communication may support different operational scenarios, such as in-coverage, out-of-coverage, and partial coverage. Out-of-coverage refers to a scenario in which UEs (e.g., UEs 238, 240 and 242) are outside the coverage are of a base station (e.g., base station 212), but each are still configured for ProSe communication. Partial coverage refers to a scenario in which a UE is outside the coverage area of a base station, while one or more other UEs in communication with the UE are in the coverage area of a base station. In-coverage refers to a scenario in which UEs (e.g., UEs 226 and 228) are in communication with a base station (e.g., base station 212) via a Uu connection (e.g., a UE to RAN cellular interface) to receive ProSe service authorization and provisioning information to support ProSe operation.

In the radio access network 200, the ability for a UE to communicate while moving, independent of its location, is referred to as mobility. The various physical channels between the UE and the radio access network are generally set up, maintained, and released under the control of an access and mobility management function (AMF). The AMF (not shown in FIG. 2) may include a security context management function (SCMF) that manages the security context for both the control plane and the user plane functionality, and a security anchor function (SEAF) that performs authentication.

A radio access network 200 may utilize DL-based mobility or UL-based mobility to enable mobility and handovers (i.e., the transfer of a UE's connection from one radio channel to another). In a network configured for DL-based mobility, during a call with a scheduling entity, or at any other time, a UE may monitor various parameters of the signal from its serving cell as well as various parameters of neighboring cells. Depending on the quality of these parameters, the UE may maintain communication with one or more of the neighboring cells. During this time, if the UE moves from one cell to another, or if signal quality from a neighboring cell exceeds that from the serving cell for a given amount of time, the UE may undertake a handoff or handover from the serving cell to the neighboring (target) cell. For example, UE 224 (illustrated as a vehicle, although any suitable form of UE may be used) may move from the geographic area corresponding to its serving cell 202 to the geographic area corresponding to a neighbor cell 206. When the signal strength or quality from the neighbor cell 206 exceeds that of its serving cell 202 for a given amount of time, the UE 224 may transmit a reporting message to its serving base station 210 indicating this condition. In response, the UE 224 may receive a handover command, and the UE may undergo a handover to the cell 206.

In a network configured for UL-based mobility, UL reference signals from each UE may be utilized by the network to select a serving cell for each UE. In some examples, the base stations 210, 212, and 214/216 may broadcast unified synchronization signals (e.g., unified Primary Synchronization Signals (PSSs), unified Secondary Synchronization Signals (SSSs) and unified Physical Broadcast Channels (PBCH)). The UEs 222, 224, 226, 228, 230, and 232 may receive the unified synchronization signals, derive the carrier frequency and slot timing from the synchronization signals, and in response to deriving timing, transmit an uplink pilot or reference signal. The uplink pilot signal transmitted by a UE (e.g., UE 224) may be concurrently received by two or more cells (e.g., base stations 210 and 214/216) within the radio access network 200. Each of the cells may measure a strength of the pilot signal, and the radio access network (e.g., one or more of the base stations 210 and 214/216 and/or a central node within the core network) may determine a serving cell for the UE 224. As the UE 224 moves through the radio access network 200, the network may continue to monitor the uplink pilot signal transmitted by the UE 224. When the signal strength or quality of the pilot signal measured by a neighboring cell exceeds that of the signal strength or quality measured by the serving cell, the network 200 may handover the UE 224 from the serving cell to the neighboring cell, with or without informing the UE 224.

Although the synchronization signal transmitted by the base stations 210, 212, and 214/216 may be unified, the synchronization signal may not identify a particular cell, but rather may identify a zone of multiple cells operating on the same frequency and/or with the same timing. The use of zones in 5G networks or other next generation communication networks enables the uplink-based mobility framework and improves the efficiency of both the UE and the network, since the number of mobility messages that need to be exchanged between the UE and the network may be reduced.

In various implementations, the air interface in the radio access network 200 may utilize licensed spectrum, unlicensed spectrum, or shared spectrum. Licensed spectrum provides for exclusive use of a portion of the spectrum, generally by virtue of a mobile network operator purchasing a license from a government regulatory body. Unlicensed spectrum provides for shared use of a portion of the spectrum without need for a government-granted license. While compliance with some technical rules is generally still required to access unlicensed spectrum, generally, any operator or device may gain access. Shared spectrum may fall between licensed and unlicensed spectrum, wherein technical rules or limitations may be required to access the spectrum, but the spectrum may still be shared by multiple operators and/or multiple RATs. For example, the holder of a license for a portion of licensed spectrum may provide licensed shared access (LSA) to share that spectrum with other parties, e.g., with suitable licensee-determined conditions to gain access.

The air interface in the radio access network 200 may utilize one or more multiplexing and multiple access algorithms to enable simultaneous communication of the various devices. For example, 5G NR specifications provide multiple access for UL transmissions from UEs 222 and 224 to base station 210, and for multiplexing for DL transmissions from base station 210 to one or more UEs 222 and 224, utilizing orthogonal frequency division multiplexing (OFDM) with a cyclic prefix (CP). In addition, for UL transmissions, 5G NR specifications provide support for discrete Fourier transform-spread-OFDM (DFT-s-OFDM) with a CP (also referred to as single-carrier FDMA (SC-FDMA)). However, within the scope of the present disclosure, multiplexing and multiple access are not limited to the above schemes, and may be provided utilizing time division multiple access (TDMA), code division multiple access (CDMA), frequency division multiple access (FDMA), sparse code multiple access (SCMA), resource spread multiple access (RSMA), or other suitable multiple access schemes. Further, multiplexing DL transmissions from the base station 210 to UEs 222 and 224 may be provided utilizing time division multiplexing (TDM), code division multiplexing (CDM), frequency division multiplexing (FDM), orthogonal frequency division multiplexing (OFDM), sparse code multiplexing (SCM), or other suitable multiplexing schemes.

The air interface in the radio access network 200 may further utilize one or more duplexing algorithms. Duplex refers to a point-to-point communication link where both endpoints can communicate with one another in both directions. Full duplex means both endpoints can simultaneously communicate with one another. Half duplex means only one endpoint can send information to the other at a time. In a wireless link, a full duplex channel generally relies on physical isolation of a transmitter and receiver, and suitable interference cancelation technologies. Full duplex emulation is frequently implemented for wireless links by utilizing frequency division duplex (FDD) or time division duplex (TDD). In FDD, transmissions in different directions operate at different carrier frequencies. In TDD, transmissions in different directions on a given channel are separated from one another using time division multiplexing. That is, at some times the channel is dedicated for transmissions in one direction, while at other times the channel is dedicated for transmissions in the other direction, where the direction may change very rapidly, e.g., several times per slot.

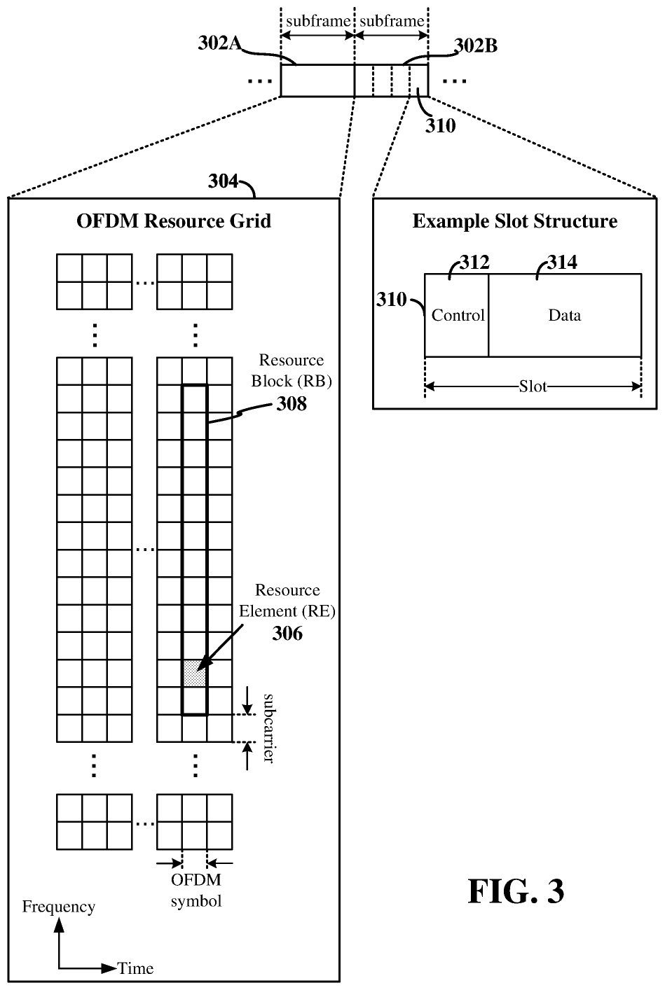

Various aspects of the present disclosure will be described with reference to an OFDM waveform, an example of which is schematically illustrated in FIG. 3. It should be understood by those of ordinary skill in the art that the various aspects of the present disclosure may be applied to an SC-FDMA waveform in substantially the same way as described herein below. That is, while some examples of the present disclosure may focus on an OFDM link for clarity, it should be understood that the same principles may be applied as well to SC-FDMA waveforms.

Referring now to FIG. 3, an expanded view of an example DL subframe (SF) 302A is illustrated, showing an OFDM resource grid 304. However, as those skilled in the art will readily appreciate, the PHY transmission structure for any particular application may vary from the example described here, depending on any number of factors. Here, time is in the horizontal direction with units of OFDM symbols; and frequency is in the vertical direction with units of subcarriers.

The resource grid 304 may be used to schematically represent time-frequency resources for a given antenna port. That is, in a multiple-input-multiple-output (MIMO) implementation with multiple antenna ports available, a corresponding multiple number of resource grids 304 may be available for communication. The resource grid 304 is divided into multiple resource elements (REs) 306. An RE, which is 1 subcarrier×1 symbol, is the smallest discrete part of the time-frequency grid, and contains a single complex value representing data from a physical channel or signal. Depending on the modulation utilized in a particular implementation, each RE may represent one or more bits of information. In some examples, a block of REs may be referred to as a physical resource block (PRB) or more simply a resource block (RB) 308, which contains any suitable number of consecutive subcarriers in the frequency domain. In one example, an RB may include 12 subcarriers, a number independent of the numerology used. In some examples, depending on the numerology, an RB may include any suitable number of consecutive OFDM symbols in the time domain. Within the present disclosure, it is assumed that a single RB such as the RB 308 entirely corresponds to a single direction of communication (either transmission or reception for a given device).

Scheduling of UEs (e.g., scheduled entities) for downlink, uplink, or sidelink transmissions typically involves scheduling one or more resource elements 306 within one or more sub-bands or bandwidth parts (BWPs). Each BWP may include two or more contiguous or consecutive RBs. Thus, a UE generally utilizes only a subset of the resource grid 304. In some examples, an RB may be the smallest unit of resources that can be allocated to a UE. Thus, the more RBs scheduled for a UE, and the higher the modulation scheme chosen for the air interface, the higher the data rate for the UE. The RBs may be scheduled by a base station (e.g., gNB, eNB, RSU, etc.) or may be self-scheduled by a UE implementing D2D sidelink communication.

In this illustration, the RB 308 is shown as occupying less than the entire bandwidth of the subframe 302A, with some subcarriers illustrated above and below the RB 308. In a given implementation, the subframe 302A may have a bandwidth corresponding to any number of one or more RBs 308. Further, in this illustration, the RB 308 is shown as occupying less than the entire duration of the subframe 302A, although this is merely one possible example.

Each 1 ms subframe 302A may consist of one or multiple adjacent slots. In the example shown in FIG. 3, one subframe 302B includes four slots 310, as an illustrative example. In some examples, a slot may be defined according to a specified number of OFDM symbols with a given cyclic prefix (CP) length. For example, a slot may include 7 or 14 OFDM symbols with a nominal CP. Additional examples may include mini-slots having a shorter duration (e.g., one or two OFDM symbols). These mini-slots may in some cases be transmitted occupying resources scheduled for ongoing slot transmissions for the same or for different UEs. Any number of resource blocks may be utilized within a subframe or slot.

An expanded view of one of the slots 310 illustrates the slot 310 including a control region 312 and a data region 314. In general, the control region 312 may carry control channels (e.g., PDCCH), and the data region 314 may carry data channels (e.g., PDSCH or PUSCH). Of course, a slot may contain all DL, all UL, or at least one DL portion and at least one UL portion. The structure illustrated in FIG. 3 is merely exemplary in nature, and different slot structures may be utilized, and may include one or more of each of the control region(s) and data region(s).

Although not illustrated in FIG. 3, the various REs 306 within a RB 308 may be scheduled to carry one or more physical channels, including control channels, shared channels, data channels, etc. Other REs 306 within the RB 308 may also carry pilots or reference signals, including but not limited to a demodulation reference signal (DMRS), a control reference signal (CRS), or a sounding reference signal (SRS). These pilots or reference signals may provide for a receiving device to perform channel estimation of the corresponding channel, which may enable coherent demodulation/detection of the control and/or data channels within the RB 308.

In some examples, a slot 310 may be utilized for broadcast or unicast communication. In V2X or D2D networks, a broadcast communication may refer to a point-to-multipoint transmission by a one device (e.g., a vehicle, base station (e.g., RSU, gNB, eNB, etc.), UE, or other similar device) to other devices. A unicast communication may refer to a point-to-point transmission by a one device to a single other device.

In an example, the control region 312 of the slot 310 may include a physical downlink control channel (PDCCH) including downlink control information (DCI) transmitted by a base station (e.g., gNB, eNB, RSU, etc.) towards one or more of a set of UEs, which may include one or more sidelink devices (e.g., V2X/D2D devices). In some examples, the DCI may include synchronization information to synchronize communication by a plurality of sidelink devices on the sidelink channel. In addition, the DCI may include scheduling information indicating one or more resource blocks within the control region 312 and/or data region 314 allocated to sidelink devices for sidelink communication. For example, the control region 312 of the slot may further include control information transmitted by sidelink devices over the sidelink channel, while the data region 314 of the slot 310 may include data transmitted by sidelink devices over the sidelink channel. In some examples, the control information may be transmitted within a physical sidelink control channel (PSCCH), while the data may be transmitted within a physical sidelink shared channel (PSSCH).

In a DL transmission, the transmitting device (e.g., the scheduling entity) may allocate one or more REs 306 (e.g., within a control region 312) to carry DL control information including one or more DL control channels, such as a PBCH; a physical control format indicator channel (PCFICH); a physical hybrid automatic repeat request (HARQ) indicator channel (PHICH); and/or a physical downlink control channel (PDCCH), etc., to one or more scheduled entities. The transmitting device may further allocate one or more REs 306 to carry other DL signals, such as a DMRS; a phase-tracking reference signal (PT-RS); a channel state information—reference signal (CSI-RS); a primary synchronization signal (PSS); and a secondary synchronization signal (SSS).

The synchronization signals PSS and SSS, and in some examples, the PBCH and a PBCH DMRS, may be transmitted in a synchronization signal block (SSB) that includes 3 consecutive OFDM symbols, numbered via a time index in increasing order from 0 to 3. In the frequency domain, the SSB may extend over 240 contiguous subcarriers, with the subcarriers being numbered via a frequency index in increasing order from 0 to 239. Of course, the present disclosure is not limited to this specific SSB configuration. Other nonlimiting examples may utilize greater or fewer than two synchronization signals; may include one or more supplemental channels in addition to the PBCH; may omit a PBCH; and/or may utilize a different number of symbols and/or nonconsecutive symbols for an SSB, within the scope of the present disclosure.

The PCFICH provides information to assist a receiving device in receiving and decoding the PDCCH. The PDCCH may carry downlink control information (DCI) including but not limited to power control commands, scheduling information, a grant, and/or an assignment of REs for DL and UL transmissions. The PHICH carries HARQ feedback transmissions such as an acknowledgment (ACK) or negative acknowledgment (NACK). HARQ is a technique well-known to those of ordinary skill in the art, wherein the integrity of packet transmissions may be checked at the receiving side for accuracy, e.g., utilizing any suitable integrity checking mechanism, such as a checksum or a cyclic redundancy check (CRC). If the integrity of the transmission confirmed, an ACK may be transmitted, whereas if not confirmed, a NACK may be transmitted. In response to a NACK, the transmitting device may send a HARQ retransmission, which may implement chase combining, incremental redundancy, etc.

In an UL transmission, the transmitting device (e.g., the scheduled entity) may utilize one or more REs 306 to carry UL control information including one or more UL control channels, such as a physical uplink control channel (PUCCH), to the scheduling entity. UL control information may include a variety of packet types and categories, including pilots, reference signals, and information configured to enable or assist in decoding uplink data transmissions. For example, the UL control information may include a DMRS or SRS. In some examples, the control information may include a scheduling request (SR), i.e., request for the scheduling entity to schedule uplink transmissions. Here, in response to the SR transmitted on the control channel, the scheduling entity may transmit downlink control information that may schedule resources for uplink packet transmissions. UL control information may also include HARQ feedback, channel state feedback (CSF), or any other suitable UL control information.

In an example of cellular communication over a cellular carrier via a Uu interface, for a DL transmission, the scheduling entity (e.g., a base station) may allocate one or more REs 306 (e.g., within the control region 312 of the slot 310) to carry DL control information including one or more DL control channels or DL signals, such as a synchronization signal block (SSB), demodulation reference signal (DMRS), channel state information—reference signal (CSI-RS), PDCCH, etc. to one or more scheduled entities (e.g., UEs). The PDCCH carries downlink control information (DCI) including, for example, scheduling information that provides a grant, and/or an assignment of REs for DL and UL transmissions.

In an UL transmission over the Uu interface, the scheduled entity may utilize one or more REs 306 to carry UL control information (UCI) including one or more UL control channels, such as a physical uplink control channel (PUCCH), to the scheduling entity. UCI may include, for example, pilots, reference signals, and information to enable or assist in decoding uplink data transmissions. For example, the UCI may include a DMRS or an SRS. In some examples, the UCI may include a scheduling request (SR), i.e., request for the scheduling entity to schedule uplink transmissions.

In addition to control information, one or more REs 306 (e.g., within the data region 314) may be allocated for user data or traffic data. Such traffic may be carried on one or more traffic channels, such as, for a DL transmission, a PDSCH; or for an UL transmission, a physical uplink shared channel (PUSCH). In some examples, one or more REs 306 within the data region 314 may be configured to carry SIB s (e.g., SIB1), carrying system information that may enable access to a given cell.

These physical channels described above are generally multiplexed and mapped to transport channels for handling at the medium access control (MAC) layer. Transport channels carry blocks of information called transport blocks (TB). The transport block size (TBS), which may correspond to a number of bits of information, may be a controlled parameter, based on the modulation and coding scheme (MCS) and the number of RBs in a given transmission.

The channels or carriers described above with reference to FIGS. 1-3 are not necessarily all of the channels or carriers that may be utilized between a scheduling entity and scheduled entities, and those of ordinary skill in the art will recognize that other channels or carriers may be utilized in addition to those illustrated, such as other traffic, control, and feedback channels.

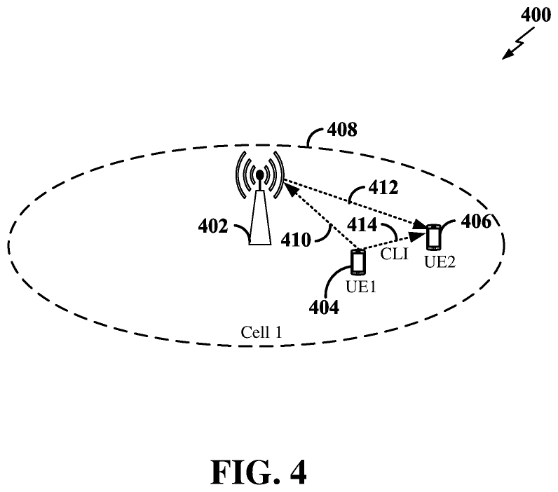

FIG. 4 illustrates an example wireless communication network 400 where a base station 402 communicates with a UE 404 (UE1) and a UE 404 (UE2) in an intra-cell deployment according to some aspects. The base station 402 (e.g., a cellular base station (e.g., a gNB as referred to in 5G NR)) provides wireless services to UEs, such as the UEs 404 and 406, within a cell coverage area 408 (referred to as Cell 1 in FIG. 4). Accordingly, as illustrated, the UEs 404 and 406 are situated within the cell coverage area 408. In some examples, the base station 402 may correspond to any of the base stations or scheduling entities shown in FIGS. 1 and/or 2. In some examples, the UEs 404 and 406 may correspond to any of the UEs or scheduled entities shown in FIGS. 1 and/or 2.

As illustrated, the UE 404 transmits an uplink (UL) signal 410 to the base station 402. In addition, the UE 406 receives a downlink (DL) signal 412 from the base station 402. These signals may be Uu signals as described herein. A portion 414 of the UL signal transmitted by the UE 404 may be received by the UE 406 while the UE 406 is receiving the DL signal 412 from the base station 402. This portion 414 of the UL signal transmitted by the UE 404 may cause interference (e.g., in the form of noise) with the reception of the DL signal 412 by the UE 406. This type of interference is referred to as cross link interference (CLI) or, more specifically, UE-to-UE CLI. The UE 404 may be referred to as an aggressor UE (A-UE) because it is the source of the interference signal, and the UE 406 may be referred to as a victim UE (V-UE) because the interference signal affects its reception of the DL signal 412 from the base station 402.

As discussed in more detail herein, the base station 402 (or the associated network) may instruct the victim UE 406 to perform measurements of the CLI and report the measurements to the base station 402. Upon receiving a CLI measurement report from the UE 406, the base station 402 may take measures to mitigate the CLI. For example, the base station 402 may configure the slot format for the aggressor UE 404 and/or the slot format for the victim UE 406 such that UL transmissions and DL receptions do not collide or coincide in the time-domain. As another example, the base station 402 may reduce the UL transmit power of the aggressor UE 404 to reduce the CLI to the victim UE 406. Other CLI mitigating measures may be taken by the base station 402.

Also, as discussed herein, a CLI measurement by the victim UE 406 may be performed by monitoring at least one resource used by the aggressor UE 404 for transmissions. For example, the victim UE 406 may determine a received signal strength indicator (RSSI) based on a measurement of the portion 414 of the UL signal transmitted by the aggressor UE 404 (e.g., estimated total energy within a particular frequency bandwidth in the portion 414 of the UL signal). Alternatively, or in addition, a CLI measurement by the victim UE 406 may be performed by determining a reference signal receive power (RSRP) based on a reference signal, such as a sounding reference signal (SRS), in the portion 414 of the UL signal transmitted by the aggressor UE 404. There may be other techniques employed by the victim UE 406 to determine the CLI caused by the portion 414 of the UL signal transmitted by the aggressor UE 404.

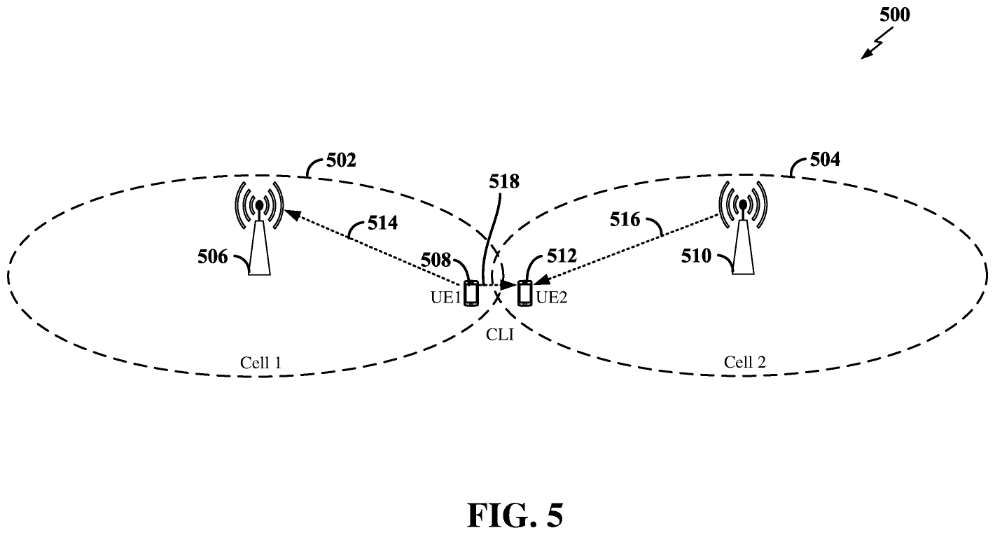

CLI may occur between UEs in the same cell as in FIG. 4 or between UEs in different cells. FIG. 5 illustrates an example where the UEs are in different cells.

FIG. 5 illustrates an example wireless communication network 500 including a first cell coverage area 502 (referred to as Cell 1) and a second cell coverage area 504 (referred to as Cell 2) in an inter-cell, homogeneous deployment according to some aspects. The base station 506 (e.g., a cellular base station (e.g., a gNB as referred to in 5G NR)) provides wireless services to UEs, such as the UE 508, within the first cell coverage area 502. Accordingly, as illustrated, the UE 508 is situated within the first cell coverage area 502. The base station 510 (e.g., a cellular base station (e.g., a gNB as referred to in 5G NR)) provides wireless services to UEs, such as the UE 512, within the second cell coverage area 504. Accordingly, as illustrated, the UE 512 is situated within the second cell coverage area 504. In some examples, the base stations 506 and 510 may correspond to any of the base stations or scheduling entities shown in any of FIGS. 1, 2, and 4. In some examples, the UEs 508 and 512 may correspond to any of the UEs or scheduled entities shown in any of FIGS. 1, 2, and 4.

This configuration of the wireless communication network 520 is referred to as an inter-cell, homogeneous deployment. That is, the configuration is an inter-cell deployment because the UE 508 is served by the first base station 506, which is different than the second base station 510 serving the UE 512. Also, the configuration is a homogeneous deployment because the first cell coverage area 502 of the first base station 506 does not substantially overlap with the second cell coverage area 504 of the second base station 510. In the homogeneous deployment, the first cell coverage area 502 may have a similar size as the second cell coverage area 504.

The UE 508 transmits an uplink (UL) signal 514 to the first base station 506. The UE 512 receives a downlink (DL) signal 516 from the second base station 510. These signals may be Uu signals as described herein. A portion 518 of the UL signal transmitted by the UE 508 may be received by the UE 512 while the UE 512 is receiving the DL signal 516 from the second base station 510. The portion 518 of the UL signal transmitted by the UE 508 may cause CLI with the reception of the DL signal 516 by the UE 512. Thus, the UE 508 is the aggressor UE (A-UE) and the UE 512 is the victim UE (V-UE) in FIG. 5.

The second base station 510 (or the associated network) may instruct the victim UE 512 to perform measurements of the CLI and report the measurements to the second base station 510. In response, the second base station 510 may take measures to mitigate the CLI, such as configure the slot format for the aggressor UE 508 (e.g., by communicating with the first base station 506 via an X2 signaling link) and/or the slot format for victim UE 512 such that the UL transmissions and the DL receptions do not collide or coincide in the time-domain. Other CLI mitigating measures may be taken by the second base station 510.

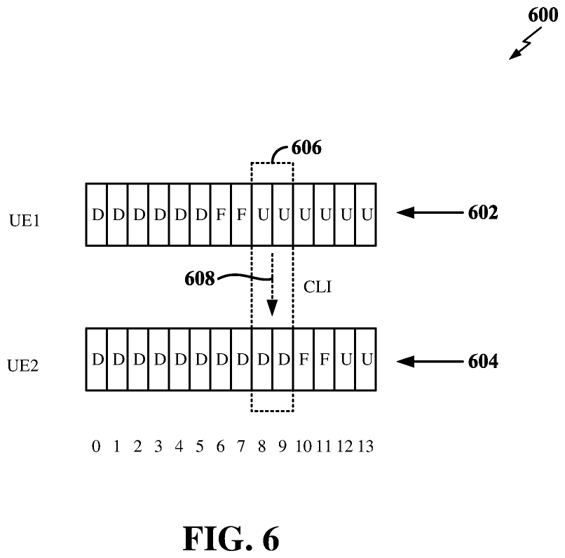

FIG. 6 illustrates an example of CLI between an UL resource for a first UE (referred to as UE1) and a DL resource for a second UE (referred to as UE2). The time-domain diagram 600 of FIG. 6 illustrates a first slot 602 scheduled for the UE1 and a second slot 604 scheduled for the UE2 according to some aspects. The horizontal axis of the time-domain diagram 600 represents time. In some examples, each slot has a length of 14 OFDM symbols (numbered 0 to 13) as defined in 5G NR. The slots may have a length with a different number of OFDM symbols in other examples.

The UE1 has a slot format with OFDM symbols 0-5 designated for downlink (D) reception, OFDM symbols 6-7 designated as flexible (eligible for either uplink (U) transmission or downlink (D) reception), and OFDM symbols 8-13 designated for uplink (U) transmission. The UE2 has a slot format with OFDM symbols 0-9 designated for downlink (D) reception, OFDM symbols 10-11 designated as flexible (eligible for either uplink (U) transmission or downlink (D) reception), and OFDM symbols 12-13 designated for uplink (U) transmission. The OFDM symbols 0-13 pertaining to the slot of UE1 is logically time-aligned with the OFDM symbols 0-13 pertaining to the slot of UE2 in this example. However, due to different propagation delays, the physical time alignments of the slots might not be exact.

As illustrated in FIG. 6, the OFDM symbols 8-9 of the UE1 slot designated for uplink (U) transmission logically coincides in the time domain with the OFDM symbols 8-9 of the UE2 slot. If the UE1 and the UE2 are sufficiently close to each other, the uplink (U) signal transmission of the UE1 during OFDM symbols 8-9 interferes with the downlink (D) signal reception of the UE2 during OFDM symbols 8-9. Thus, as represented by the dashed rectangle 606 around OFDM symbols 8-9 of the slots of the UE1 and the UE2, cross link interference (CLI) 608 may occur at the receiver of the UE2. As such, the UE2 might not be able to receive and decode the downlink (D) signal due to the CLI.

The slot formats of the UE1 and the UE2 may be independent of each other. That is, OFDM symbols designated for downlink in the slot format for one of the UEs need not coincide in time with OFDM symbols designated for uplink in the slot format for the other one of the UEs. Thus, when the victim UE is receiving, the aggressor UE may or may not be transmitting. The UE performs CLI measurements based on a scheduling configuration, and does not depend on the slot format of potential aggressor UEs in some examples.

In view of the above, CLI measurements may be used for Uu interference management to address DL/UL symbol pattern differences between UEs (e.g., as shown in FIG. 6). For example, a base station may configure UEs to monitor for CLI on a periodic or other time and frequency basis, as discussed further herein. Thus, a victim UE may perform CLI measurement on a CLI resource specified in a CLI configuration (e.g., generated by a base station) where the CLI resource corresponds to the resource that the aggressor UE uses for a transmission.

The CLI measurement procedure may include the following operations, with reference to the UE1 and the UE2 of FIGS. 4-6. The UE1 conducts an uplink transmission to its serving base station on a particular resource. The UE2 is configured with a corresponding CLI measurement resource. For example, the base station may send a CLI configuration to the UE2 that specifies a CLI resource that corresponds to the same time and frequency resources that are used by the UE1 for its uplink transmission. Based on the CLI configuration, the UE2 measures CLI on the configured resource. For example, the UE2 may measure RSSI and/or RSRP. The UE2 then reports the results of the measurement to the network (e.g., the base station).

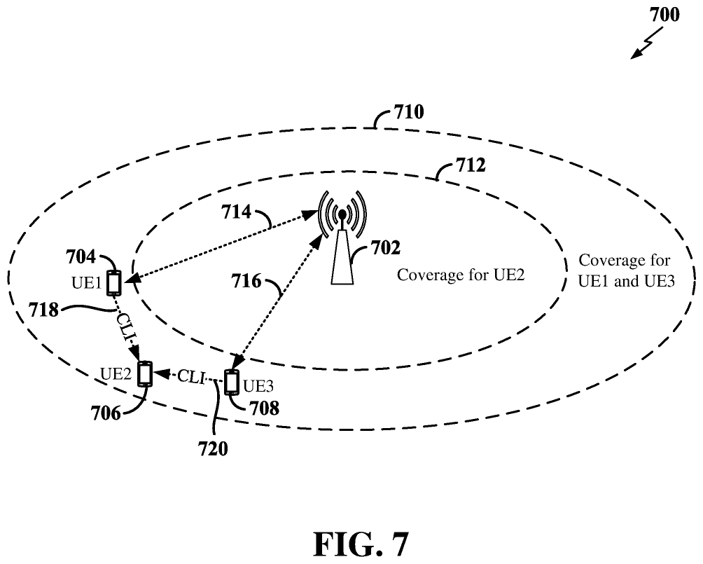

Conventionally, the CLI measurement configuration for CLI measurements of NR signals is provided by a base station as discussed above. However, in some situations, a network-based CLI resource configuration is not available. For example, if the UE (e.g., a reduced capability (RedCap) UE) has lower coverage capability than a regular UE (e.g., due to the RedCap UE having fewer antennas and/or smaller sized antennas), the RedCap UE may be out of coverage of the network even though other nearby UEs are within the coverage of the network. In this case, the CLI configuration cannot be directly provided to the RedCap UE by the base station. FIG. 7 illustrates an example of this scenario.

FIG. 7 illustrates an example wireless communication network 700 where a base station 702 may communicate with a UE 704 (UE1), a UE 706 (UE2), and a UE 708 (UE3) in an intra-cell deployment according to some aspects. In some examples, the base station 702 may correspond to any of the base stations or scheduling entities shown in any of FIGS. 1, 2, 4, and 5. In some examples, the UEs 704, 706, and 708 may correspond to any of the UEs or scheduled entities shown in any of FIGS. 1, 2, 4, and 5.

The base station 702 (e.g., a cellular base station (e.g., a gNB as referred to in 5G NR)) provides wireless services to UEs, such as the UEs 704 and 708, within a cell coverage area 710. For example, the UE 704 may communicate with the base station 702 via Uu signaling 714. In addition, the UE 708 may communicate with the base station 702 via Uu signaling 716. Due to the limited capability of UE 706, however, the base station 702 provides wireless services to the UE 706 within a smaller cell coverage area 712. Thus, in the example of FIG. 7, the UE 706 is unable to directly communicate with the base station 702 via Uu signaling (e.g., UL and DL signaling) at its current location.

The UE 704 may transmit an uplink (UL) signal to the base station 702 via the Uu signaling 714. A portion 718 of the UL signal transmitted by the UE 704 may be received by the UE 706 as CLI.

Similarly, the UE 708 may transmit an uplink (UL) signal to the base station 702 via the Uu signaling 716. A portion 720 of the UL signal transmitted by the UE 708 may be received by the UE 706 as CLI.

However, as discussed above, since the UE 706 is not within the cell coverage area 712, the base station 702 is not able to directly send a CLI configuration to the UE 706 to request the UE 706 to conduct CLI measurements. Consequently, the base station is unable to alleviate the CLI issue in this scenario.

The disclosure relates in some aspects to using a UE that is within coverage of a cellular network (e.g., the cell coverage area of a base station) to exchange CLI-related information with a UE (e.g., a RedCap UE) that is not within coverage of the cellular network.

The disclosure also relates in some aspects to using a CLI measurement to measure the pathloss or range between a set of UEs. This pathloss or range information may be used, for example, for UE-based positioning enhancements. However, using Uu CLI resources configured by a base station could use up considerable Uu resources that may be better used for other purposes. That is, Uu signaling-based CLI measurements between UEs may be inefficient.

The disclosure thus relates in some aspects to using sidelink signals to configure and conduct CLI measurements for UE positioning applications. For example, a UE (e.g., referred to as a positioning UE) may act as a coordinator to schedule CLI measurements on one or more sidelink channels. Here, both the CLI scheduling and the CLI measurements may be conducted on sidelink resources, thereby preserving Uu resources for other uses. In some aspects, this sidelink-based UE positioning technique may enhance the coverage of the CLI measurements (e.g., since UEs that are out of coverage of the network may still conduct CLI measurements) and save the resource costs of the CLI resource configuration (e.g., by avoiding using Uu resources for at least some of the CLI measurements).

The disclosure relates in some aspects to two modes of CLI measurement configuration. Both of these modes may be used, for example, to enable a UE (e.g., a RedCap UE) that is out of network coverage to obtain a CLI measurement configuration and/or report a CLI measurement.

In the first mode (Mode 1), a first UE (a UE that is connected to the network) relays a network's CLI configuration to a second UE (e.g., an out of coverage UE). For example, the first UE may relay a CLI measurement configuration from a network that is responsible for scheduling the second UE for CLI measurements. Thus, in Mode 1, the connected UE acts as a relay.

In the second mode (Mode 2), a first UE (e.g., a UE that is connected to the network) generates a CLI configuration for a second UE (e.g., an out of coverage UE). In some examples, the first UE may use its own CLI configuration previously provided by the network (or a subset of resources or measurement occasions of the configuration) as the CLI configuration for the second UE.

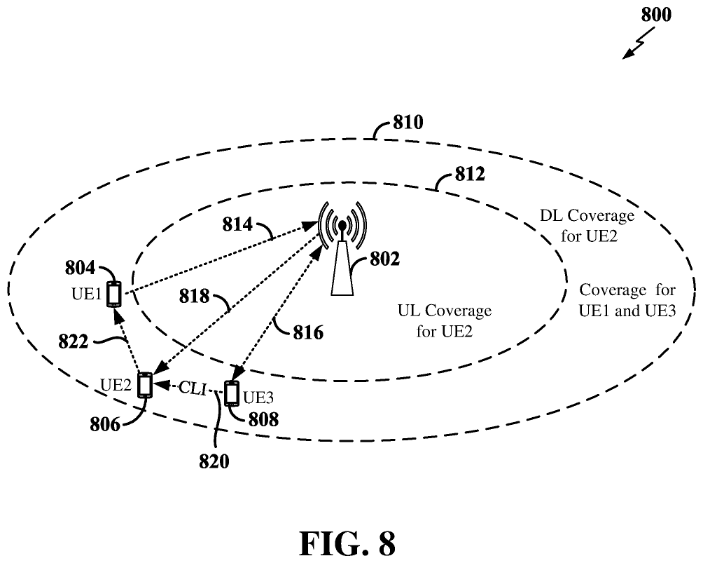

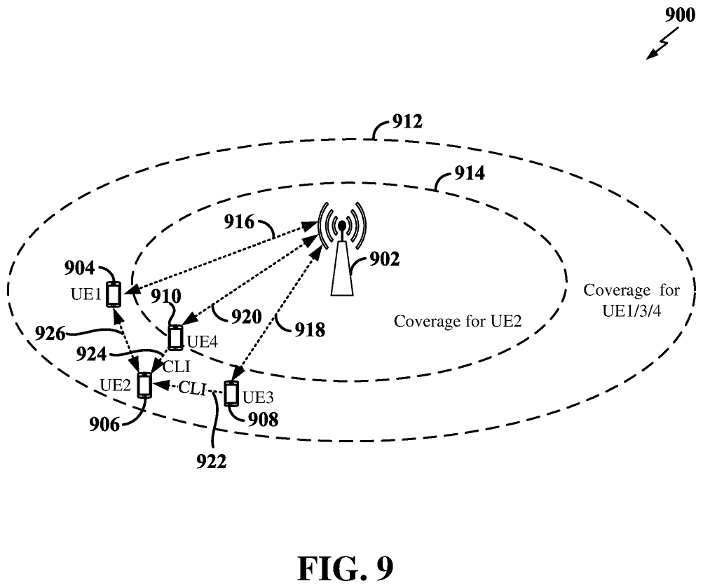

In both Mode 1 and Mode 2, the connected UE maintains a connection with base station and also maintains a sidelink connection with at least one other UE (which may be referred to as a CLI UE herein). Mode 1 will be described in more detail with reference to FIGS. 8 and 9.

FIG. 8 illustrates a scenario where base station is able to send a CLI configuration to a UE but is unable to receive a CLI measurement report from the UE. Here, the DL has sufficient coverage so that the CLI UE (e.g., UE2) is able to receive a CLI resource configuration from its serving base station. However, the UL for the CLI UE has limited coverage (e.g., due to limited transmit capability of the CLI UE). Thus, the CLI UE is not able to directly send a measurement report to the base station via an UL channel. In this case, the connected UE may act as the UL CLI report relay. That is, the connected UE (e.g., UE1) may relay a CLI measurement report generated by the CLI UE to the base station.

FIG. 8 illustrates an example wireless communication network 800 where a base station 802 may communicate with a UE 804 (UE1), a UE 806 (UE2), and a UE 808 (UE3) in an intra-cell deployment according to some aspects. In some examples, the base station 802 may correspond to any of the base stations or scheduling entities shown in any of FIGS. 1, 2, 4, 5, 6, and 7. In some examples, the UEs 804, 806, and 808 may correspond to any of the UEs or scheduled entities shown in any of FIGS. 1, 2, 4, 5, 6, and 7.

The base station 802 (e.g., a cellular base station (e.g., a gNB as referred to in 5G NR)) provides wireless services to UEs, such as the UEs 804, 806, and 808, within a cell coverage area 810. For example, the UE 804 may communicate with the base station 802 via Uu signaling 814. In addition, the UE 808 may communicate with the base station 802 via Uu signaling 816. Due to the limited capability of UE 806, however, the base station 802 might only provide downlink service to the UE 806 within the cell coverage area 810 via Uu signaling 818. For example, due to limited transmit power of the UE 806, the base station 802 might only provide uplink service to the UE 806 within a smaller cell coverage area 812.

The UE 808 may transmit an uplink (UL) signal to the base station 802 via the Uu signaling 816. A portion 820 of the UL signal transmitted by the UE 808 may be received by the UE 806 as CLI.

The base station may send a CLI configuration to the UE 806 instructing the UE 806 to measure CLI on a resource used for the UL transmission by the UE 808. In this case, since the UE 806 is not able to directly send the CLI measurement report to the base station 802 via UL signaling (e.g., Uu signaling), the UE 806 may send the measurement report to the UE 804 via a sidelink 822, whereby the UE 806 relays the measurement report to the base station (e.g., via Uu signaling 814).

FIG. 9 illustrates a scenario where a base station is unable to directly communicate with a UE on either the DL or the UL. In this case, a connected UE may act as a CLI configuration relay. For example, a base station may configure a UE (e.g., UE1) that is connected to the base station to relay a CLI resource configuration from the base station to the CLI UE (e.g., UE2). In addition, the base station may configure the connected UE (e.g., UE1) to relay a CLI measurement report generated by the CLI UE (e.g., UE2) to the base station. This latter operation might not be used for UE-based positioning applications. In some examples, the base station may configure the connected UE using an RRC configuration.

FIG. 9 illustrates an example wireless communication network 900 where a base station 902 may communicate with a UE 904 (UE1), a UE 906 (UE2), a UE 908 (UE3), and a UE 910 (UE4) in an intra-cell deployment according to some aspects. In some examples, the base station 902 may correspond to any of the base stations or scheduling entities shown in any of FIGS. 1, 2, 4, 5, 6, 7, and 8. In some examples, the UEs 904, 906, 908, and 910 may correspond to any of the UEs or scheduled entities shown in any of FIGS. 1, 2, 4, 5, 6, 7, and 8.

The base station 902 (e.g., a cellular base station (e.g., a gNB as referred to in 5G NR)) provides wireless services to UEs, such as the UEs 904, 908, and 910, within a cell coverage area 912. For example, the UE 904 may communicate with the base station 902 via Uu signaling 916. In addition, the UE 908 may communicate with the base station 902 via Uu signaling 918. Also, the UE 910 may communicate with the base station 902 via Uu signaling 920. Due to the limited capability of UE 906, however, the base station 902 might only provide service to the UE 906 within a smaller cell coverage area 914. Thus, in the example of FIG. 9, the UE 906 is unable to directly communicate with the base station 902 via Uu signaling (e.g., UL and DL signaling) at its current position.

The UE 908 may transmit an uplink (UL) signal to the base station 902 via the Uu signaling 918. A portion 922 of the UL signal transmitted by the UE 908 may be received by the UE 906 as CLI.

Similarly, the UE 910 may transmit an uplink (UL) signal to the base station 902 via the Uu signaling 920. A portion 924 of the UL signal transmitted by the UE 910 may be received by the UE 906 as CLI.

Since the base station 902 is unable to send a CLI configuration to the UE 906 directly in this scenario, the base station 902 may send a CLI configuration for the UE 906 to the UE 904 via sidelink signaling 926. The UE 904 may then relay the CLI configuration to the UE 906. In this case, since the UE 906 is not able to directly send the CLI measurement report to the base station 902 via UL signaling (e.g., Uu signaling), the UE 906 may send the measurement report to the UE 904 via the sidelink signaling 926, whereby the UE 906 relays the measurement report to the base station (e.g., via Uu signaling 916).

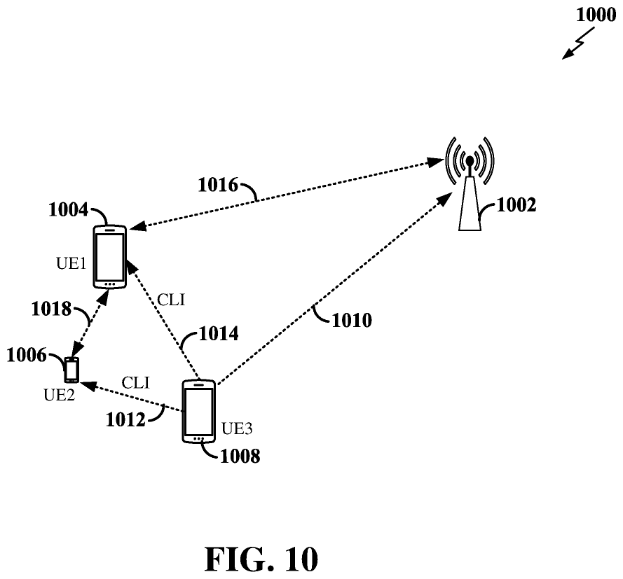

Mode 2 mentioned above will be described in more detail with reference to FIGS. 10-13. Mode 2 may include two sub-modes: Mode 2-1 and Mode 2-2.

In Mode 2-1, a connected UE may use its own CLI configuration provided by network to schedule the CLI measurement for the CLI UE. The gNB configures the CLI resource for the UE1 for UE1's CLI measurement from a UE3 or other aggressor UEs. Thus, the UE1 has CLI configuration from a gNB and also has a sidelink connection with a UE2.

The base station may configure the UE1 to act as a coordinator to schedule the UE2 for a CLI measurement. Here, the UE1 allocates the CLI resource to the UE2. In some examples, the UE1 may deliver its own UL resource (SRS) as the CLI resource to UE2. In some examples, this CLI scheduling may be done via a sidelink channel between the UE1 and the UE2. In some examples, the base station may configure the UE1 using an RRC configuration.

Once configured to measure CLI, the UE2 measures the signals in the specified CLI resource. In Mode 2-1, the CLI resource is a Uu resource. The CLI resource may include the coordinator itself. The CLI resource may include the CLI resource configured for the UE1. After measuring the CLI, the UE reports the CLI measurements to the UE1 via a sidelink channel.

The UE1 may then take various actions based on the CLI measurement information. In some examples, the UE1 determines the CLI interference level at the UE2 based on the CLI measurement information. In some examples, the UE1 conducts UE positioning operation (e.g., determining the position of UE1 based on known positions of the other UEs) based on the CLI measurement information.

FIG. 10 illustrates an example wireless communication network 1000 where a base station 1002 communicates with a UE 1004 (UE1), a UE 1006 (UE2), and a UE 1008 (UE3) in an intra-cell deployment according to some aspects. In some examples, the base station 1002 may correspond to any of the base stations or scheduling entities shown in any of FIGS. 1, 2, 4, 5, 6, 7, 8, and 9. In some examples, the UEs 1004, 1006, and 1008 may correspond to any of the UEs or scheduled entities shown in any of FIGS. 1, 2, 4, 5, 6, 7, 8, and 9.

The UE 1008 may transmit an uplink (UL) signal to the base station 1002 via Uu signaling 1010. A portion 1012 of the UL signal transmitted by the UE 1008 may be received by the UE 1006 as CLI. A portion 1014 of the UL signal transmitted by the UE 1008 may also be received by the UE 1004 as CLI.

Since the base station 1002 is unable to send a CLI configuration to the UE 1006 directly in this scenario, the base station 1002 may configure the UE 1004 as a CLI coordinator (e.g., by sending an RRC message via Uu signaling 1016). The UE 1004 may then generate and send a CLI configuration for the UE 1006 to the UE 1004 via sidelink signaling 1018.

In the Mode 2-2, a connected UE may use a subset of sidelink resources or sidelink measurement occasions for the CLI measurements. Here, the UE1 acts as a coordinator to allocate a CLI measurement resource from the available sidelink resources. Thus, in this mode, the CLI resource is from the set of sidelink resources.

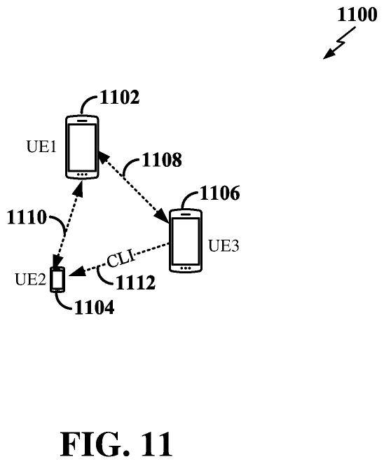

FIG. 11 illustrates an example wireless communication network 1100 where a UE 1102 (UE1), a UE 1104 (UE2), and a UE 1106 (UE3) communicate via sidelink signaling. In some examples, the UEs 1102, 1104, and 1106 may correspond to any of the UEs or scheduled entities shown in any of FIGS. 1, 2, 4, 5, 6, 7, 8, 9, and 10.

In a scenario where the UE 1102 is a CLI coordinator, the UE 1102 may schedule the UE 1106 (via sidelink signaling 1108) to transmit on a particular sidelink resource. The UE 1102 may then generate and send a CLI configuration to the UE 1104 via sidelink signaling 1110. Here, the CLI configuration may specify that the UE 1104 is to monitor the particular sidelink resource for the CLI 1112.

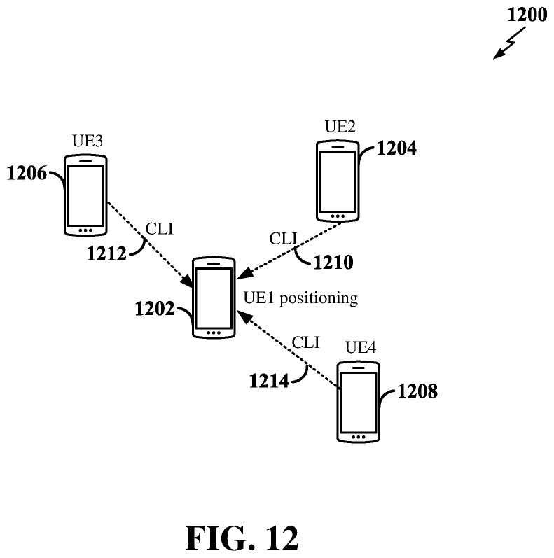

In the Mode 2-2, a connected UE may also use the sidelink channels to nearby UEs to conduct UE positioning as discussed above. FIG. 12 illustrates an example of this sidelink-based UE positioning.

FIG. 12 illustrates an example wireless communication network 1200 where a UE 1202 (UE1), a UE 1204 (UE2), a UE 1206 (UE3), and a UE 1208 (UE4) communicate via sidelink signaling. In some examples, the UEs 1202, 1204, 1206, and 1208 may correspond to any of the UEs or scheduled entities shown in any of FIGS. 1, 2, 4, 5, 6, 7, 8, 9, 10, and 11.

The UE 1202 may configure the UE 1204, the UE 1206, and the UE 1208 (e.g., via corresponding sidelink channels) to transmit on corresponding CLI resources. The UE 1202 may then measure CLI signals from the UE 1204 (e.g., sidelink signaling 1210), CLI signals from the UE 1206 (e.g., sidelink signaling 1212), and CLI signals from the UE 1208 (e.g., sidelink signaling 1214). The UE 1204 may then generate position information based on these measurements (e.g., by determining the distance to each UE based on the path loss to each UE).

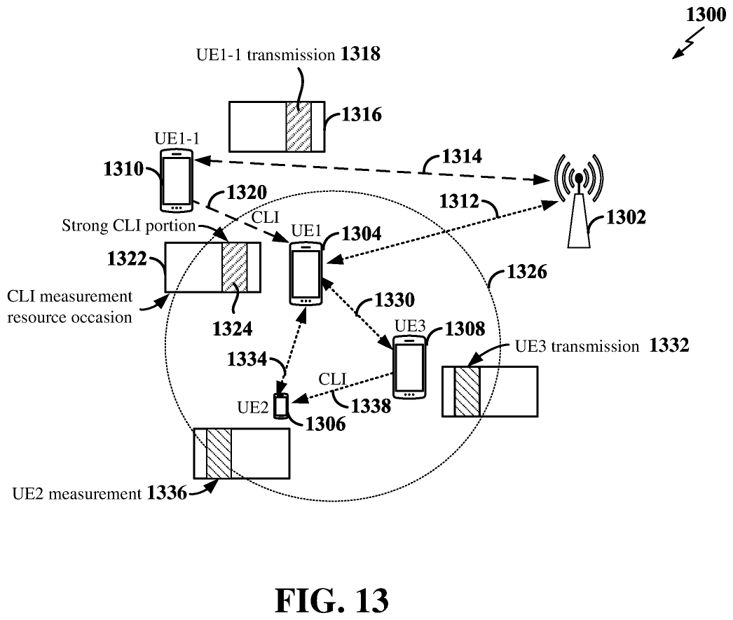

Referring to FIG. 13, for a CLI resource configuration in Mode 1, a connected UE relays the Uu CLI resource configuration that the network generated for the out of network UE. Thus, in Mode 1, the connected UE does not utilize this particular CLI resource.

In contrast, for a CLI resource configuration in Mode 2-1, the connected UE may use its own configured CLI resource to schedule a CLI measurement by another UE (e.g., an out of network UE). In addition, in Mode 2-2, the connected UE allocates a subset of the CLI resources or configures the measurement occasions for the other UE CLI measurements on sidelink resources.

FIG. 13 illustrates an example where a connected UE acting as a coordinator may select the resources to be used for CLI measurements by a UE to avoid transmissions by other UEs. For example, the connected UE may monitor a CLI measurement resource occasion to determine whether the connected UE is receiving strong CLI from another UE during a portion of the CLI measurement resource occasion. If so, the connected UE may schedule other UEs to conduct CLI measurements on a different portion of the CLI measurement resource occasion.

FIG. 13 illustrates an example wireless communication network 1300 where a base station 1302 communicates with a UE 1304 (UE1), a UE 1306 (UE2), a UE 1308 (UE3), and a UE 1310 (UE1-1) in an intra-cell deployment according to some aspects. In some examples, the base station 1302 may correspond to any of the base stations or scheduling entities shown in any of FIGS. 1, 2, 4, 5, 6, 7, 8, 9, 10, 11, and 12. In some examples, the UEs 1304, 1306, 1308, and 1310 may correspond to any of the UEs or scheduled entities shown in any of FIGS. 1, 2, 4, 5, 6, 7, 8, 9, 10, 11, and 12.

The UE 1310 may communicate with the base station 1302 via Uu signaling 1312. The UE 1310 may transmit an uplink (UL) signal to the base station 1302 via Uu signaling 1314 on an allocated resources 1316. For example, the UE 1310 may transmit the UL signal on a subset (e.g., one or more symbols) 1318 of the allocated resources 1316. A portion 1320 of the UL signal transmitted by the UE 1310 may be received by the UE 1304 as CLI. By measuring the transmissions of the UE 1310 during a CLI measurement resource occasion 1322, the UE 1304 may identify the subset of resources (e.g., symbols) 1324 subject to strong CLI from the UE 1310.

In a scenario where the UE 1304 is a CLI coordinator for a set of UEs 1326, the UE 1304 may schedule the UE 1308 (via sidelink signaling 1130) to transmit on a particular sidelink resource 1332 that avoids the strong CLI from the UE 1310. The UE 1304 may then generate and send a CLI configuration to the UE 1306 via sidelink signaling 1334. Here, the CLI configuration may specify that the UE 1306 is to measure the particular sidelink resource 1336 for the CLI 1338 from the UE 1308.

Mode switching may be employed based on different use cases (or purposes). In some examples, to enhance coverage of a low tier UE (e.g., a RedCap UE), Mode 1 (relay connected UE) may be used. In some examples, to provide UE positioning enhancement using CLI measurements, mode 2 may be used. In some examples, if there is no available CLI resource configured (e.g., as in a self-organized network where a Uu resource for CLI measurement has not been configured), Mode 2-2 may be used. In this case, sidelink resources may be used for the CLI measurement. In some examples, if a CLI procedure is restricted to Uu CLI measurements, Mode 1 or Mode 2-1 may be used to conduct CLI measurements on Uu CLI resources. In some examples, a mode switch may be based on a UE capability. For example, if the connected UE has relay capability but does not support the CLI coordinator function or if the connected UE has band limitations, Mode 1 may be used.

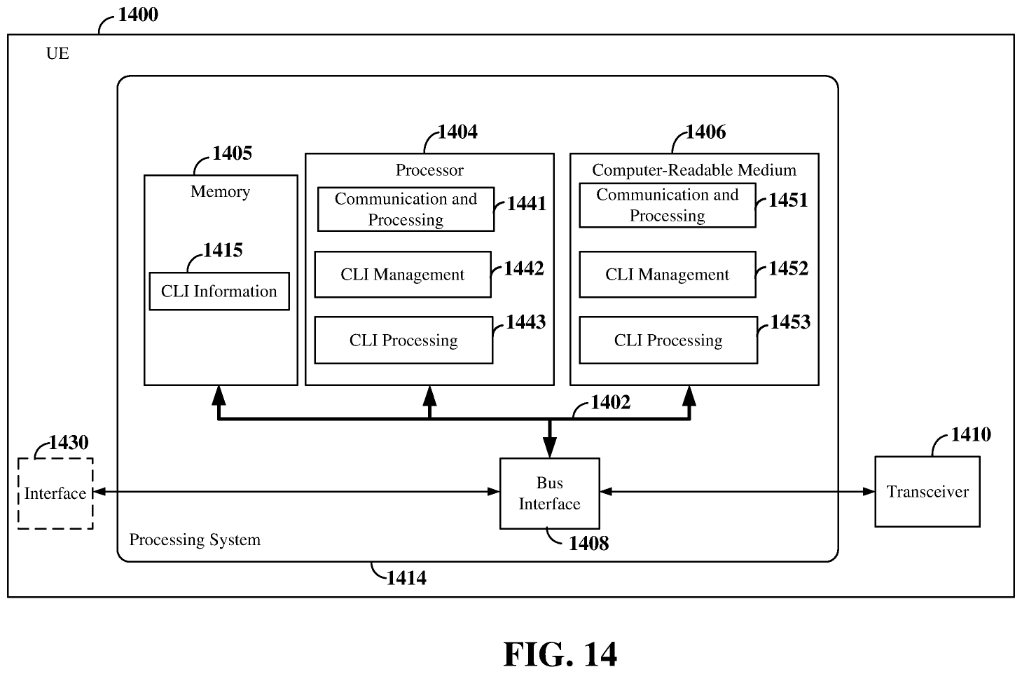

FIG. 14 is a block diagram illustrating an example of a hardware implementation for a UE 1400 employing a processing system 1414. For example, the UE 1400 may be a sidelink device or other device configured to wirelessly communicate with a base station, as discussed in any one or more of FIGS. 1-13. In some implementations, the UE 1400 may correspond to any of the UEs or scheduled entities shown in any of FIGS. 1, 2, 10, 5, 7, 8, 9, 10, 11, 12, and 13.

In accordance with various aspects of the disclosure, an element, or any portion of an element, or any combination of elements may be implemented with the processing system 1414. The processing system 1414 may include one or more processors 1404. Examples of processors 1404 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. In various examples, the UE 1400 may be configured to perform any one or more of the functions described herein. That is, the processor 1404, as utilized in a UE 1400, may be used to implement any one or more of the processes and procedures described herein.

The processor 1404 may in some instances be implemented via a baseband or modem chip and in other implementations, the processor 1404 may itself comprise a number of devices distinct and different from a baseband or modem chip (e.g., in such scenarios as may work in concert to achieve embodiments discussed herein). And as mentioned above, various hardware arrangements and components outside of a baseband modem processor can be used in implementations, including RF-chains, power amplifiers, modulators, buffers, interleavers, adders/summers, etc.

In this example, the processing system 1414 may be implemented with a bus architecture, represented generally by the bus 1402. The bus 1402 may include any number of interconnecting buses and bridges depending on the specific application of the processing system 1414 and the overall design constraints. The bus 1402 communicatively couples together various circuits including one or more processors (represented generally by the processor 1404), a memory 1405, and computer-readable media (represented generally by the computer-readable medium 1406). The bus 1402 may also link various other circuits such as timing sources, peripherals, voltage regulators, and power management circuits, which are well known in the art, and therefore, will not be described any further. A bus interface 1408 provides an interface between the bus 1402 and a transceiver 1410 and between the bus 1402 and an interface 1430. The transceiver 1410 provides a communication interface or means for communicating with various other apparatus over a wireless transmission medium. In some examples, the UE may include two or more transceivers 1410, each configured to communicate with a respective network type (e.g., terrestrial or non-terrestrial). The interface 1430 provides a communication interface or means of communicating with various other apparatuses and devices (e.g., other devices housed within the same apparatus as the UE or other external apparatuses) over an internal bus or external transmission medium, such as an Ethernet cable. Depending upon the nature of the apparatus, the interface 1430 may include a user interface (e.g., keypad, display, speaker, microphone, joystick). Of course, such a user interface is optional, and may be omitted in some examples, such as an IoT device.

The processor 1404 is responsible for managing the bus 1402 and general processing, including the execution of software stored on the computer-readable medium 1406. The software, when executed by the processor 1404, causes the processing system 1414 to perform the various functions described below for any particular apparatus. The computer-readable medium 1406 and the memory 1405 may also be used for storing data that is manipulated by the processor 1404 when executing software.

One or more processors 1404 in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium 1406.

The computer-readable medium 1406 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium 1406 may reside in the processing system 1414, external to the processing system 1414, or distributed across multiple entities including the processing system 1414. The computer-readable medium 1406 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

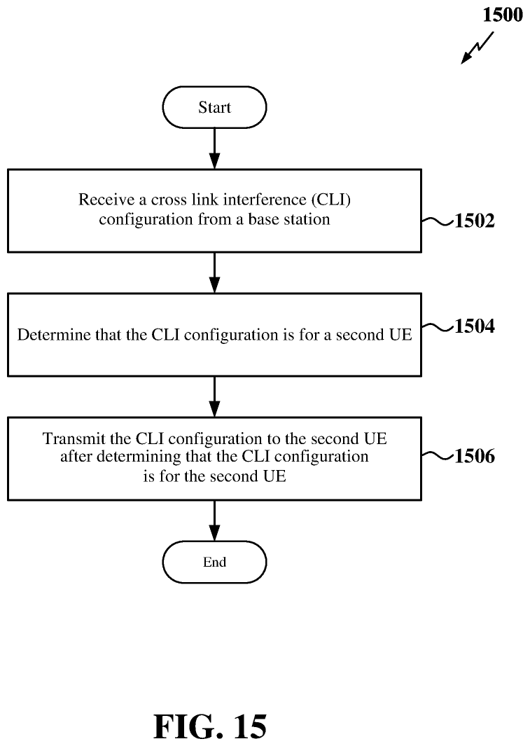

The UE 1400 may be configured to perform any one or more of the operations described herein (e.g., as described above in conjunction with FIGS. 1-13 and as described below in conjunction with FIGS. 15-17). In some aspects of the disclosure, the processor 1404, as utilized in the UE 1400, may include circuitry configured for various functions.

The processor 1404 may include communication and processing circuitry 1441. The communication and processing circuitry 1441 may be configured to communicate with a base station, such as a gNB. The communication and processing circuitry 1441 may include one or more hardware components that provide the physical structure that performs various processes related to wireless communication (e.g., signal reception and/or signal transmission) as described herein. The communication and processing circuitry 1441 may further include one or more hardware components that provide the physical structure that performs various processes related to signal processing (e.g., processing a received signal and/or processing a signal for transmission) as described herein. In some examples, the communication and processing circuitry 1441 may include two or more transmit/receive chains, each configured to process signals in a different RAT (or RAN) type. The communication and processing circuitry 1441 may further be configured to execute communication and processing software 1451 included on the computer-readable medium 1406 to implement one or more functions described herein.

In some examples, the communication and processing circuitry 1441 may be configured to generate and transmit a scheduling request (e.g., via UCI in a PUCCH) to the base station to receive an uplink grant for the PUSCH. The communication and processing circuitry 1441 may further be configured to generate an uplink signal and interact with the transceiver 1410 to transmit the uplink signal. The uplink signal may include, for example, a PUCCH, a PUSCH, an SRS, a DMRS, or a PRACH. The communication and processing circuitry 1441 may further be configured to interact with the transceiver 1410 to monitor for a downlink signal and decode a downlink signal. The downlink signal may include, for example, a PDCCH, a PDSCH, a CSI-RS, or a DMRS.

The communication and processing circuitry 1441 configured to communicate over a sidelink carrier to exchange sidelink control information and sidelink data with other sidelink devices. In some examples, the communication and processing circuitry 1441 may be configured to transmit a PSCCH, which may include a sidelink synchronization signal block (S-SSB), other control information, and/or pilot signals, and/or a PSSCH, which may include sidelink data, within a radio frame based on sidelink transmission timing. In some examples, the sidelink transmission timing may be determined based on synchronization to a synchronization source (e.g., gNB, eNB, GNSS, etc.), self-synchronization to an internal timing/frequency reference, or synchronization to another sidelink device (e.g., based on a received S-SS as described herein).

In some implementations where the communication involves receiving information, the communication and processing circuitry 1441 may obtain information from a component of the UE 1400 (e.g., from the transceiver 1410 that receives the information via radio frequency signaling or some other type of signaling suitable for the applicable communication medium), process (e.g., decode) the information, and output the processed information. For example, the communication and processing circuitry 1441 may output the information to another component of the processor 1404, to the memory 1405, or to the bus interface 1408. In some examples, the communication and processing circuitry 1441 may receive one or more of signals, messages, other information, or any combination thereof. In some examples, the communication and processing circuitry 1441 may receive information via one or more channels. In some examples, the communication and processing circuitry 1441 may include functionality for a means for receiving.

In some implementations where the communication involves sending (e.g., transmitting) information, the communication and processing circuitry 1441 may obtain information (e.g., from another component of the processor 1404, the memory 1405, or the bus interface 1408), process (e.g., encode) the information, and output the processed information. For example, the communication and processing circuitry 1441 may output the information to the transceiver 1410 (e.g., that transmits the information via radio frequency signaling or some other type of signaling suitable for the applicable communication medium). In some examples, the communication and processing circuitry 1441 may send one or more of signals, messages, other information, or any combination thereof. In some examples, the communication and processing circuitry 1441 may send information via one or more channels. In some examples, the communication and processing circuitry 1441 may include functionality for a means for sending (e.g., means for transmitting).

The processor 1404 may include CLI management circuitry 1442 configured to perform CLI management-related operations as discussed herein. The CLI management circuitry 1442 may include functionality for a means for receiving a CLI configuration. The CLI management circuitry 1442 may include functionality for a means for determining that a CLI configuration is for another UE. The CLI management circuitry 1442 may include functionality for a means for transmitting a CLI configuration. The CLI management circuitry 1442 may include functionality for a means for receiving a message that configures the UE to schedule CLI measurements. The CLI management circuitry 1442 may include functionality for a means for generating a CLI configuration. The CLI management circuitry 1442 may include functionality for a means for electing to use a UE to schedule CLI measurements. The CLI management circuitry 1442 may include functionality for a means for generating a message to configure a UE to schedule CLI measurements. The CLI management circuitry 1442 may include functionality for a means for transmitting the message to a UE. The CLI management circuitry 1442 may further be configured to execute CLI management software 1452 included on the computer-readable medium 1406 to implement one or more functions described herein.

The processor 1404 may include CLI processing circuitry 1443 configured to perform CLI processing-related operations as discussed herein. The CLI processing circuitry 1443 may include functionality for a means for measuring signals on a CLI resource. The CLI processing circuitry 1443 may include functionality for a means for generating a CLI measurement report. The CLI processing circuitry 1443 may include functionality for a means for transmitting a CLI measurement report. The CLI processing circuitry 1443 may include functionality for a means for receiving a CLI measurement report. The CLI processing circuitry 1443 may include functionality for a means for processing a CLI measurement report. The CLI processing circuitry 1443 may further be configured to execute CLI processing software 1453 included on the computer-readable medium 1406 to implement one or more functions described herein.

FIG. 15 is a flow chart illustrating an example method 1500 for a wireless communication system in accordance with some aspects of the present disclosure. As described below, some or all illustrated features may be omitted in a particular implementation within the scope of the present disclosure, and some illustrated features may not be required for implementation of all embodiments. In some examples, the method 1500 may be carried out by the UE 1400 illustrated in FIG. 14. In some examples, the method 1500 may be carried out by any suitable apparatus or means for carrying out the functions or algorithm described below.

At block 1502, a UE (e.g., the UE1 described above) may receive a cross link interference (CLI) configuration from a base station. For example, the CLI management circuitry 1442 together with the communication and processing circuitry 1441 and the transceiver 1410, shown and described above in connection with FIG. 14, may receive an RRC configuration message that includes a CLI configuration from a gNB.

In some examples, the CLI configuration specifies at least one CLI resource for the second UE to measure for a CLI measurement report. In some examples, the at least one CLI resource may include a resource allocated to the first UE for an uplink transmission to the base station. In some examples, the at least one CLI resource may include a resource allocated to a third UE for an uplink transmission to the base station.

At block 1504, the UE may determine that the CLI configuration is for a second UE. For example, the CLI management circuitry 1442, shown and described above in connection with FIG. 14, may determine that a CLI configuration received from a gNB is destined for another UE. In some examples, an RRC configuration message that carries the CLI configuration may indicate that the CLI configuration is for a particular. In this case, determining that the CLI configuration is for a second UE may include parsing the RRC message to determine whether the CLI configuration is destined for the UE or for another UE.

At block 1506, the UE may transmit the CLI configuration to the second UE after determining that the CLI configuration is for the second UE. For example, the CLI management circuitry 1442 together with the communication and processing circuitry 1441 and the transceiver 1410, shown and described above in connection with FIG. 14, may extract a CLI configuration from a received RRC message and relay the extracted CLI configuration to the second UE. In some examples, transmitting the CLI configuration may include transmitting the CLI configuration via a sidelink channel to the second UE.

In some examples, the method may further include receiving a CLI measurement report from the second UE after transmitting the CLI configuration to the second UE, determining that the CLI measurement report is for the base station, and transmitting the CLI measurement report to the base station after determining that the CLI measurement report is for the base station. In some examples, the CLI measurement report indicates a signal measurement by the second UE on at least one CLI resource specified by the CLI configuration. In some examples, the at least one CLI resource may include a resource allocated to the first UE for an uplink transmission to the base station. In some examples, the at least one CLI resource may include a resource allocated to a third UE for an uplink transmission to the base station.

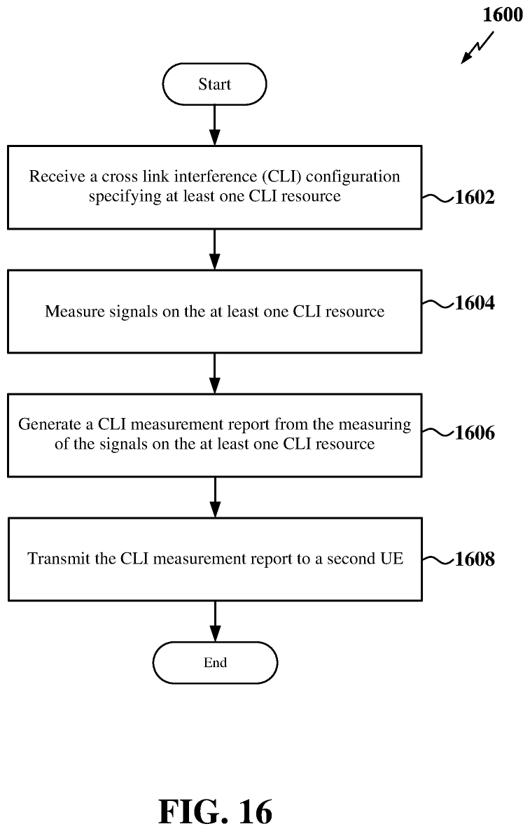

FIG. 16 is a flow chart illustrating an example method 1600 for a wireless communication system in accordance with some aspects of the present disclosure. As described below, some or all illustrated features may be omitted in a particular implementation within the scope of the present disclosure, and some illustrated features may not be required for implementation of all embodiments. In some examples, the method 1600 may be carried out by the UE 1400 illustrated in FIG. 14. In some examples, the method 1600 may be carried out by any suitable apparatus or means for carrying out the functions or algorithm described below.

At block 1602, a UE (e.g., the UE2 described above) may receive a cross link interference (CLI) configuration specifying at least one CLI resource. For example, the CLI management circuitry 1442 together with the communication and processing circuitry 1441 and the transceiver 1410, shown and described above in connection with FIG. 14, may receive an RRC configuration message that includes a CLI configuration from a gNB. As another example, the CLI management circuitry 1442 together with the communication and processing circuitry 1441 and the transceiver 1410, shown and described above in connection with FIG. 14, may receive a sidelink message that includes a CLI configuration generated by or relayed by another UE.

In some examples, receiving the CLI configuration may include receiving the CLI configuration from a base station. In some examples, the CLI configuration indicates that the at least one CLI resource is an uplink resource or a sidelink resource.

At block 1604, the UE may measure signals on the at least one CLI resource. For example, the CLI processing circuitry 1443 together with the communication and processing circuitry 1441 and the transceiver 1410, shown and described above in connection with FIG. 14, may measure RSSI and/or RSRP on a CLI resource (e.g., a Uu resource or a sidelink resource) specified in a CLI configuration.

At block 1606, the UE may generate a CLI measurement report from the measuring of the signals on the at least one CLI resource. For example, the CLI processing circuitry 1443, shown and described above in connection with FIG. 14, may generate a report message that indicates the RSSI and/or RSRP measured on a CLI resource. This message may indicate whether the report is destined for a gNB or a coordinator UE.

At block 1608, the UE may transmit the CLI measurement report to a second UE. For example, the CLI processing circuitry 1443 together with the communication and processing circuitry 1441 and the transceiver 1410, shown and described above in connection with FIG. 14, may transmit the report to a coordinator UE that generated the CLI configuration. As another example, the CLI processing circuitry 1443 together with the communication and processing circuitry 1441 and the transceiver 1410, shown and described above in connection with FIG. 14, may transmit the report to a relay UE that forwards the report to a gNB that generated the CLI configuration. In some examples, transmitting the CLI measurement report may include transmitting the CLI measurement report via a sidelink channel to the second UE.

In some examples, the method may further include determining that the first UE cannot communicate with the base station via an uplink channel. In this case, transmitting the CLI measurement report may include transmitting the CLI measurement report via a sidelink channel to the second UE after determining that the first UE cannot communicate with the base station via the uplink channel.

In some examples, receiving the CLI configuration may include receiving the CLI configuration from the second UE. In some examples, receiving the CLI configuration from the second UE may include receiving the CLI configuration via a sidelink channel from the second UE. In some examples, the CLI configuration indicates that the first UE is to send a CLI measurement report to a base station. In some examples, the at least one CLI resource may include a resource allocated by the base station for an uplink transmission by the second UE or a third UE to the base station. In some examples, the CLI configuration indicates that the first UE is to send a CLI measurement report to the second UE.

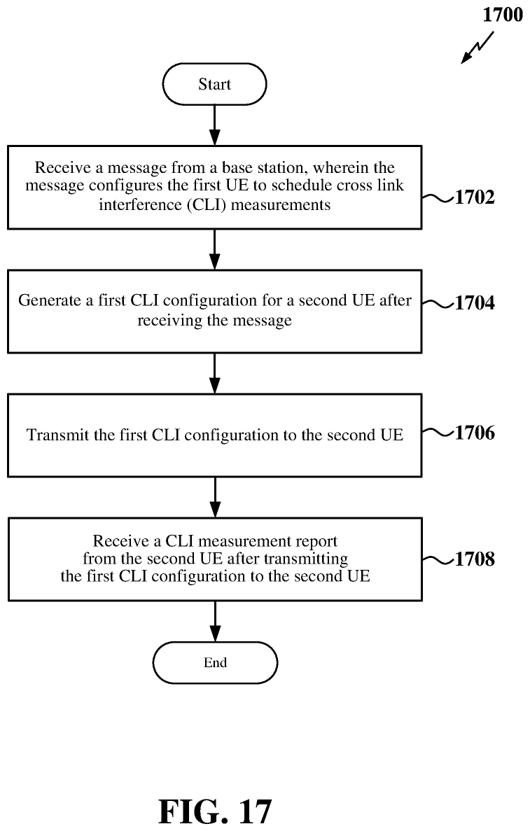

FIG. 17 is a flow chart illustrating an example method 1700 for a wireless communication system in accordance with some aspects of the present disclosure. As described below, some or all illustrated features may be omitted in a particular implementation within the scope of the present disclosure, and some illustrated features may not be required for implementation of all embodiments. In some examples, the method 1700 may be carried out by the UE 1400 illustrated in FIG. 14. In some examples, the method 1700 may be carried out by any suitable apparatus or means for carrying out the functions or algorithm described below.

At block 1702, a UE (e.g., the UE1 described above) may receive a message from a base station, wherein the message configures the first UE to schedule cross link interference (CLI) measurements. For example, the CLI management circuitry 1442 together with the communication and processing circuitry 1441 and the transceiver 1410, shown and described above in connection with FIG. 14, may receive an RRC configuration message from a gNB, where the RRC configuration message specifies that the UE is to act as a coordinator for scheduling other CLI measurements by other UEs.

At block 1704, the UE may generate a first CLI configuration for a second UE after receiving the message. For example, the CLI management circuitry 1442, shown and described above in connection with FIG. 14, may identifying a resource (e.g., a Uu resource or a CLI resource) to be measured by the second UE (e.g., a nearby UE) and generate a CLI configuration that specifies that resource. In some examples, the identified resource is a CLI resource that a gNB scheduled for the UE. In some examples, the identified resource is a sidelink resource that the UE identified as a resource that is used for transmission by a third UE that is near the second UE.

At block 1706, the UE may transmit the first CLI configuration to the second UE. For example, the CLI management circuitry 1442 together with the communication and processing circuitry 1441 and the transceiver 1410, shown and described above in connection with FIG. 14, may send the DLI configuration to the second UE over a resource allocated for D2D communication. In some examples, transmitting the first CLI configuration may include transmitting the first CLI configuration via a sidelink channel to the second UE.

At block 1708, the UE may receive a CLI measurement report from the second UE after transmitting the first CLI configuration to the second UE. For example, the CLI processing circuitry 1443 together with the communication and processing circuitry 1441 and the transceiver 1410, shown and described above in connection with FIG. 14, may monitor a resource allocated for D2D communication to receive the CLI measurement from the second UE. In some examples, receiving the CLI measurement report may include receiving the CLI measurement report via the sidelink channel from the second UE.

In some examples, the method may further include receiving a second CLI configuration from the base station. In this case, the second CLI configuration may specify at least one CLI resource for the first UE to measure. In addition, generating the first CLI configuration may include selecting a first resource of the at least one CLI resource for the second UE to measure and including an indication of the first resource in the first CLI configuration. In some examples, the at least one CLI resource may include a resource allocated to a third UE for an uplink transmission to the base station.

In some examples, generating the first CLI configuration may include selecting a sidelink resource for the second UE to measure and including an indication of the sidelink resource in the first CLI configuration. In some examples, the sidelink resource may include a resource allocated to a third UE for a sidelink transmission.

In some examples, generating the first CLI configuration may include identifying interference on a first set of resources of a plurality of resources, selecting a sidelink resource for the second UE to measure from a second set of resources of the plurality of resources, and including an indication of the sidelink resource in the first CLI configuration. In this case, the second set of resources may be different from the first set of resources.

In some examples, the method may further include extracting CLI signal measurement information from the CLI measurement report. In some examples, the method may further include calculating a level of CLI at the second UE from the CLI signal measurement information.

In some examples, the method may further include extracting CLI signal measurement information from the CLI measurement report. In some examples, the method may further include calculating UE position information from the CLI signal measurement information.

In some examples, the method may further include electing to use the CLI measurements to determine UE positioning. In this case, generating the first CLI configuration may include selecting a sidelink resource for the second UE to measure after electing to use the CLI measurements to determine UE positioning.

In some examples, the method may further include determining that a Uu CLI resource is not currently configured. In some examples, the method may further include electing to use a sidelink resource for the CLI measurements after determining that the Uu CLI resource is not currently configured.

In some examples, the method may further include determining that Uu CLI resources are to be used for the CLI measurements. In this case, generating the first CLI configuration may include selecting a Uu resource for the second UE to measure after determining that Uu CLI resources are to be used for the CLI measurements.

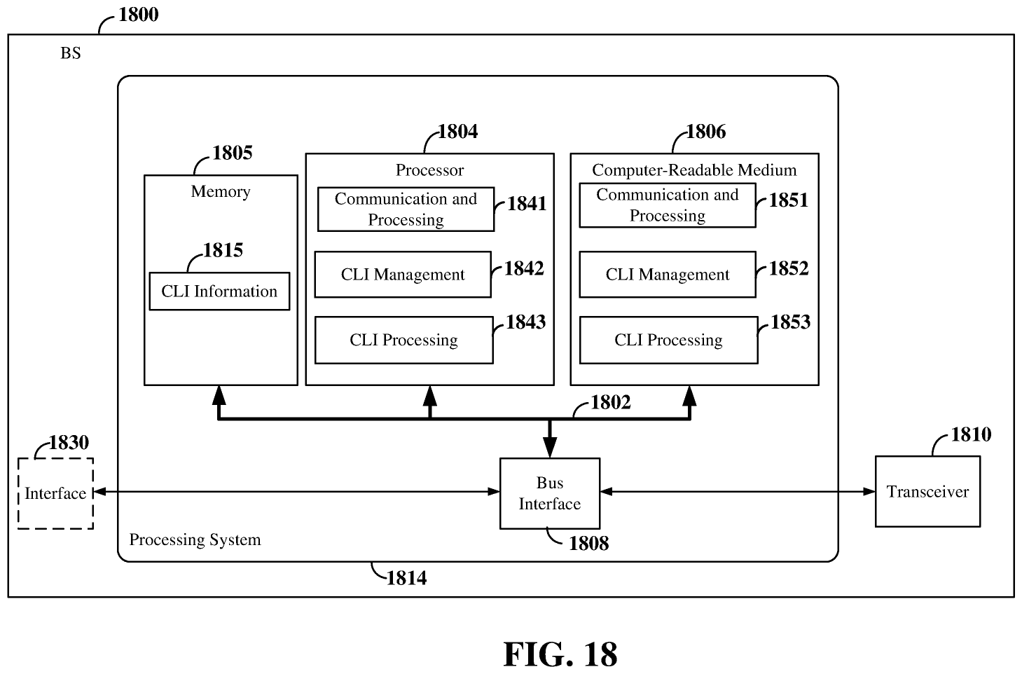

FIG. 18 is a conceptual diagram illustrating an example of a hardware implementation for base station (BS) 1800 employing a processing system 1814. In some implementations, the BS 1800 may correspond to any of the BSs (e.g., gNBs,) or scheduling entities shown in any of FIGS. 1, 2, 4, 5, 7, 8, 9, 10, and 13.

In accordance with various aspects of the disclosure, an element, or any portion of an element, or any combination of elements may be implemented with the processing system 1814. The processing system may include one or more processors 1804. The processing system 1814 may be substantially the same as the processing system 1414 illustrated in FIG. 14, including a bus interface 1808, a bus 1802, memory 1805, a processor 1804, and a computer-readable medium 1806. Furthermore, the BS 1800 may include an interface 1830 (e.g., a network interface) that provides a means for communicating with at least one other apparatus within a core network and with at least one radio access network.

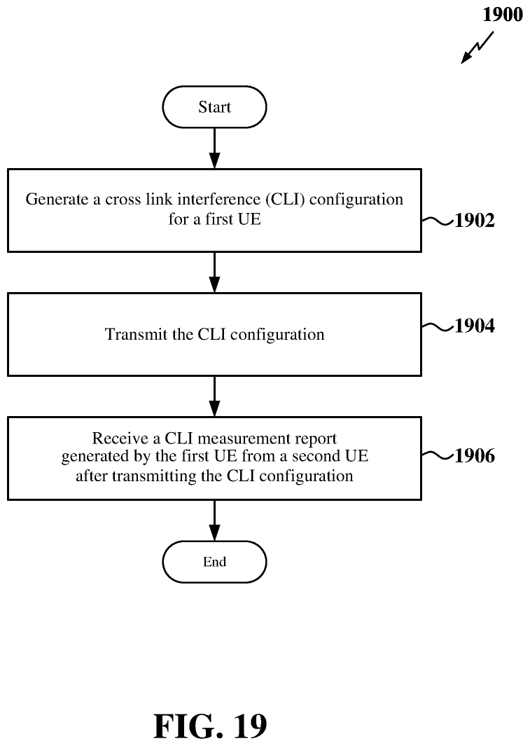

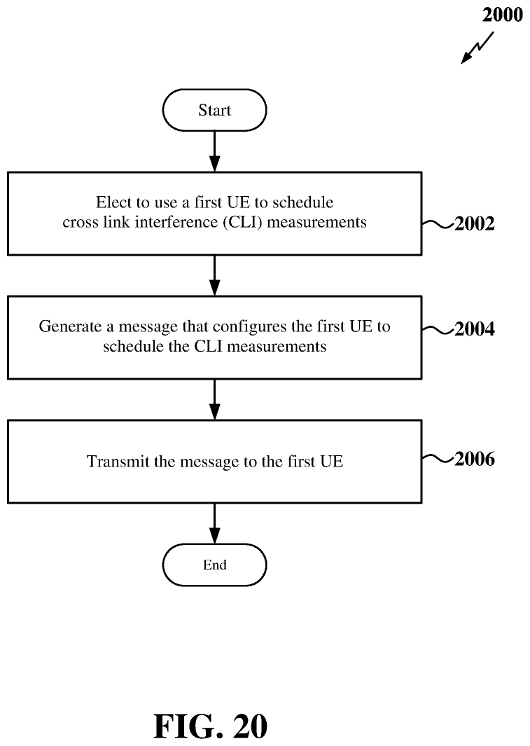

The BS 1800 may be configured to perform any one or more of the operations described herein (e.g., as described above in conjunction with FIGS. 1-13 and as described below in conjunction with FIGS. 19 and 20). In some aspects of the disclosure, the processor 1804, as utilized in the BS 1800, may include circuitry configured for various functions.

The processor 1804 may be configured to generate, schedule, and modify a resource assignment or grant of time-frequency resources (e.g., a set of one or more resource elements). For example, the processor 1804 may schedule time-frequency resources within a plurality of time division duplex (TDD) and/or frequency division duplex (FDD) subframes, slots, and/or mini-slots to carry user data traffic and/or control information to and/or from multiple UEs.

The processor 1804 may be configured to schedule resources for the transmission of a downlink signal. The downlink signal may include, for example, a PDCCH, a PDSCH, a CSI-RS, or a DMRS. The processor 1804 may further be configured to schedule resources that may be utilized by a UE to transmit an uplink signal. The uplink signal may include, for example, a PUCCH, a PUSCH, an SRS, a DMRS, or a PRACH. The processor 1804 may further be configured to schedule resources that may be utilized by a UE to transmit and/or receive a sidelink signal.

In some aspects of the disclosure, the processor 1804 may include communication and processing circuitry 1841. The communication and processing circuitry 1844 may be configured to communicate with a UE. The communication and processing circuitry 1841 may include one or more hardware components that provide the physical structure that performs various processes related to communication (e.g., signal reception and/or signal transmission) as described herein. The communication and processing circuitry 1841 may further include one or more hardware components that provide the physical structure that performs various processes related to signal processing (e.g., processing a received signal and/or processing a signal for transmission) as described herein. The communication and processing circuitry 1841 may further be configured to execute communication and processing software 1851 included on the computer-readable medium 1806 to implement one or more functions described herein. The communication and processing circuitry 1841 may further be configured to interact with the transceiver 1810 to encode and transmit a downlink signal. The communication and processing circuitry 1841 may further be configured to interact with the transceiver 1810 to monitor for and decode an uplink signal.

In some implementations where the communication involves receiving information, the communication and processing circuitry 1841 may obtain information from a component of the BS 1800 (e.g., from the transceiver 1810 that receives the information via radio frequency signaling or some other type of signaling suitable for the applicable communication medium), process (e.g., decode) the information, and output the processed information. For example, the communication and processing circuitry 1841 may output the information to another component of the processor 1804, to the memory 1805, or to the bus interface 1808. In some examples, the communication and processing circuitry 1841 may receive one or more of signals, messages, other information, or any combination thereof. In some examples, the communication and processing circuitry 1841 may receive information via one or more channels. In some examples, the communication and processing circuitry 1841 may include functionality for a means for receiving.

In some implementations where the communication involves sending (e.g., transmitting) information, the communication and processing circuitry 1841 may obtain information (e.g., from another component of the processor 1804, the memory 1805, or the bus interface 1808), process (e.g., encode) the information, and output the processed information. For example, the communication and processing circuitry 1841 may output the information to the transceiver 1810 (e.g., that transmits the information via radio frequency signaling or some other type of signaling suitable for the applicable communication medium). In some examples, the communication and processing circuitry 1841 may send one or more of signals, messages, other information, or any combination thereof. In some examples, the communication and processing circuitry 1841 may send information via one or more channels. In some examples, the communication and processing circuitry 1841 may include functionality for a means for sending (e.g., means for transmitting).

The processor 1804 may include CLI management circuitry 1842 configured to perform CLI management-related operations as discussed herein. The CLI management circuitry 1842 may include functionality for a means for generating a CLI configuration. The CLI management circuitry 1842 may include functionality for a means for transmitting a CLI configuration. The CLI management circuitry 1842 may include functionality for a means for electing to use a UE to schedule CLI measurements. The CLI management circuitry 1842 may include functionality for a means for generating a message to configure a UE to schedule CLI measurements. The CLI management circuitry 1842 may include functionality for a means for transmitting the message to a UE. The CLI management circuitry 1842 may further be configured to execute CLI management software 1852 included on the computer-readable medium 1806 to implement one or more functions described herein.

The processor 1804 may include CLI processing circuitry 1843 configured to perform CLI processing-related operations as discussed herein. The CLI processing circuitry 1843 may include functionality for a means for receiving a CLI measurement report. The CLI processing circuitry 1843 may include functionality for a means for processing a CLI measurement report. The CLI processing circuitry 1843 may further be configured to execute CLI processing software 1853 included on the computer-readable medium 1806 to implement one or more functions described herein.

FIG. 19 is a flow chart illustrating an example method 1900 for a wireless communication system in accordance with some aspects of the present disclosure. As described below, some or all illustrated features may be omitted in a particular implementation within the scope of the present disclosure, and some illustrated features may not be required for implementation of all embodiments. In some examples, the method 1900 may be carried out by the BS 1800 illustrated in FIG. 18. In some examples, the method 1900 may be carried out by any suitable apparatus or means for carrying out the functions or algorithm described below.

At block 1902, a BS may generate a cross link interference (CLI) configuration for a first UE. For example, the CLI management circuitry 1842, shown and described above in connection with FIG. 18, may determine that the first UE is subject to interference identifying a resource (e.g., a Uu resource) to be measured by the first UE (e.g., a nearby UE) and generate a CLI configuration that specifies that resource. (e.g., based on information received from the first UE explicitly indicating errors associated with

At block 1904, the BS may transmit the CLI configuration. For example, the CLI management circuitry 1842 together with the communication and processing circuitry 1841 and the transceiver 1810, shown and described above in connection with FIG. 18, may send the DLI configuration (e.g., via a downlink) to a UE that is to perform a CLI measurement. As another example, the CLI management circuitry 1842 together with the communication and processing circuitry 1841 and the transceiver 1810, shown and described above in connection with FIG. 18, may send the CLI configuration (e.g., via a Uu link) to a first UE that is to relay the CLI configuration to a UE that is to perform a CLI measurement.

In some examples, transmitting the CLI configuration may include transmitting the CLI configuration to the first UE via a connection to the first UE. In some examples, transmitting the CLI configuration may include transmitting the CLI configuration to the second UE via a connection to the second UE. In some examples, transmitting the CLI configuration may include transmitting a message indicating that the second UE is to forward the CLI configuration to the first UE.

At block 1906, the BS may receive a CLI measurement report generated by the first UE from a second UE after transmitting the CLI configuration. For example, the CLI processing circuitry 1843 together with the communication and processing circuitry 1841 and the transceiver 1810, shown and described above in connection with FIG. 18, may receive the CLI measurement report (e.g., via a Uu link) from a second UE that relays the CLI configuration from a first UE that performed a CLI measurement.

In some examples, the method may further include determining that the base station cannot communicate with the second UE. In some examples, the method may further include electing to use the first UE to relay the CLI configuration to the second UE after determining that the base station cannot communicate with the second UE.

In some examples, the method may further include determining that the base station cannot communicate with the first UE via a first downlink channel. In this case, transmitting the CLI configuration may include transmitting the CLI configuration to the second UE via a second downlink channel after determining that the base station cannot communicate with the first UE via the first downlink channel.

In some examples, the method may further include determining that the base station cannot communicate with the first UE via a first downlink channel. In some examples, the method may further include determining that the second UE has a sidelink connection to the first UE. In this case, transmitting the CLI configuration may include transmitting the CLI configuration to the second UE via a second downlink channel after determining that the base station cannot communicate with the first UE via the first downlink channel and after determining that the second UE has the sidelink connection to the first UE.

In some examples, the method may further include determining that Uu CLI resources are to be used for CLI measurements. In some examples, the method may further include electing to use the first UE to relay the CLI configuration to the second UE after determining that Uu CLI resources are to be used for CLI measurements. In this case, the CLI configuration may specify at least one Uu resource.

In some examples, the method may further include determining that the second UE does not support a CLI coordinator function. In some examples, the method may further include electing to use the second UE to relay the CLI configuration to the second UE after determining that the second UE does not support the CLI coordinator function.

FIG. 20 is a flow chart illustrating an example method 2000 for a wireless communication system in accordance with some aspects of the present disclosure. As described below, some or all illustrated features may be omitted in a particular implementation within the scope of the present disclosure, and some illustrated features may not be required for implementation of all embodiments. In some examples, the method 2000 may be carried out by the BS 1800 illustrated in FIG. 18. In some examples, the method 2000 may be carried out by any suitable apparatus or means for carrying out the functions or algorithm described below.

At block 2002, a BS may elect to use a first UE to schedule cross link interference (CLI) measurements. For example, the CLI management circuitry 1842, shown and described above in connection with FIG. 18, may determine that CLI measurements for a set of sidelink devices are to be conducted using sidelink resources.

At block 2004, the BS may generate a message that configures the first UE to schedule the CLI measurements. For example, the CLI management circuitry 1842, shown and described above in connection with FIG. 18, may generate an RRC configuration message that specifies that the first UE is to act as a coordinator to schedule other UEs to conduct CLI measurements.

In some examples, the message configures the first UE to schedule the CLI measurements on at least one uplink resource. In some examples, the message configures the first UE to schedule the CLI measurements on at least one sidelink resource.

At block 2006, the BS may transmit the message to the first UE. For example, the CLI management circuitry 1842 together with the communication and processing circuitry 1841 and the transceiver 1810, shown and described above in connection with FIG. 18, may send an RRC configuration message (e.g., via a downlink) to a sidelink UE.

In some examples, the method may further include determining that the base station cannot communicate with the first UE. In this case, generating the message that configures the first UE to schedule the CLI measurements may be triggered by the determining that the base station cannot communicate with the first UE.

In some examples, the method may further include determining that the base station cannot communicate with the first UE. In some examples, the method may further include determining that the second UE has a sidelink connection to the first UE. In this case, generating the message that configures the first UE to schedule the CLI measurements may be triggered by the determining that the base station cannot communicate with the first UE and by the determining that the second UE has the sidelink connection to the first UE.

In some examples, the method may further include electing to use the CLI measurements to determine UE positioning. In this case, electing to use the first UE to schedule the CLI measurements may be triggered by the electing to use the CLI measurements to determine UE positioning.

In some examples, the method may further include determining that a Uu CLI resource is not currently configured. In some examples, the method may further include electing to use a sidelink resource for the CLI measurements after determining that the Uu CLI resource is not currently configured.

In some examples, the method may further include determining that Uu CLI resources are to be used for the CLI measurements. In this case, electing to use the first UE to schedule the CLI measurements may be triggered by the determining that Uu CLI resources are to be used for CLI measurements.

In some examples, the method may further include generating a CLI configuration for the first UE. In some examples, the method may further include transmitting the CLI configuration to the first UE. In some examples, the method may further include receiving a CLI measurement report generated by the first UE after transmitting the CLI configuration. In some examples, the method may further include determining a level of CLI at the first UE from the CLI measurement report.

Several aspects of a wireless communication network have been presented with reference to an example implementation. As those skilled in the art will readily appreciate, various aspects described throughout this disclosure may be extended to other telecommunication systems, network architectures and communication standards.

By way of example, various aspects may be implemented within other systems defined by 3GPP, such as Long-Term Evolution (LTE), the Evolved Packet System (EPS), the Universal Mobile Telecommunication System (UMTS), and/or the Global System for Mobile (GSM). Various aspects may also be extended to systems defined by the 3rd Generation Partnership Project 2 (3GPP2), such as CDMA2000 and/or Evolution-Data Optimized (EV-DO). Other examples may be implemented within systems employing IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another—even if they do not directly physically touch each other. For instance, a first object may be coupled to a second object even though the first object is never directly physically in contact with the second object. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure. As used herein, the term “determining” may include, for example, ascertaining, resolving, selecting, choosing, establishing, calculating, computing, processing, deriving, investigating, looking up (e.g., looking up in a table, a database or another data structure), and the like. Also, “determining” may include receiving (e.g., receiving information), accessing (e.g., accessing data in a memory), and the like.

One or more of the components, steps, features and/or functions illustrated in FIGS. 1-20 may be rearranged and/or combined into a single component, step, feature or function or embodied in several components, steps, or functions. Additional elements, components, steps, and/or functions may also be added without departing from novel features disclosed herein. The apparatus, devices, and/or components illustrated in FIGS. 1, 2, 4, 5, 7, 8, 9, 10, 11, 12, 13, 14, and 18 may be configured to perform one or more of the methods, features, or steps escribed herein. The novel algorithms described herein may also be efficiently implemented in software and/or embedded in hardware.

It is to be understood that the specific order or hierarchy of steps in the methods disclosed is an illustration of example processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b, and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. A method of wireless communication at a first user equipment (UE), the method comprising:
receiving a cross link interference (CLI) configuration from a base station;
determining that the CLI configuration is for a second UE; and
transmitting the CLI configuration to the second UE after determining that the CLI configuration is for the second UE.

2. The method of claim 1, wherein transmitting the CLI configuration comprises:
transmitting the CLI configuration via a sidelink channel to the second UE.

3. The method of claim 1, wherein the CLI configuration specifies at least one CLI resource for the second UE to measure for a CLI measurement report.

4-9. (canceled)

10. A first user equipment (UE), comprising:
a transceiver;
a memory; and
a processor communicatively coupled to the transceiver and the memory, wherein the processor and the memory are configured to:
receive a cross link interference (CLI) configuration from a base station via the transceiver;
determine that the CLI configuration is for a second UE; and
transmit the CLI configuration to the second UE after determining that the CLI configuration is for the second UE.

11. The first user equipment of claim 10, wherein the processor and the memory are further configured to:
transmit the CLI configuration via a sidelink channel to the second UE.

12. The first user equipment of claim 10, wherein the CLI configuration specifies at least one CLI resource for the second UE to measure for a CLI measurement report.

13. The first user equipment of claim 12, wherein the at least one CLI resource comprises a resource allocated to the first UE for an uplink transmission to the base station.

14. The first user equipment of claim 12, wherein the at least one CLI resource comprises a resource allocated to a third UE for an uplink transmission to the base station.

15. The first user equipment of claim 10, wherein the processor and the memory are further configured to:
receive a CLI measurement report from the second UE after transmitting the CLI configuration to the second UE;
determine that the CLI measurement report is for the base station; and
transmit the CLI measurement report to the base station after determining that the CLI measurement report is for the base station.

16. The first user equipment of claim 15, wherein the CLI measurement report indicates a signal measurement by the second UE on at least one CLI resource specified by the CLI configuration.

17. The first user equipment of claim 16, wherein the at least one CLI resource comprises a resource allocated to the first UE for an uplink transmission to the base station.

18. The first user equipment of claim 16, wherein the at least one CLI resource comprises a resource allocated to a third UE for an uplink transmission to the base station.

19-20. (canceled)

21. A method of wireless communication at a first user equipment (UE), the method comprising:
receiving a cross link interference (CLI) configuration specifying at least one CLI resource;
measuring signals on the at least one CLI resource;
generating a CLI measurement report from the measuring of the signals on the at least one CLI resource; and
transmitting the CLI measurement report to a second UE.

22. The method of claim 21, wherein transmitting the CLI measurement report comprises:
transmitting the CLI measurement report via a sidelink channel to the second UE.

23-29. (canceled)

30. A first user equipment, comprising:
a transceiver;
a memory; and
a processor communicatively coupled to the transceiver and the memory, wherein the processor and the memory are configured to:
receive a cross link interference (CLI) configuration specifying at least one CLI resource;
measure signals on the at least one CLI resource;
generate a CLI measurement report from the measuring of the signals on the at least one CLI resource; and
transmit the CLI measurement report to a second UE via the transceiver.

31. The first user equipment of claim 30, wherein the processor and the memory are further configured to:
transmit the CLI measurement report via a sidelink channel to the second UE.

32. The first user equipment of claim 30, wherein:
the processor and the memory are further configured to receive the CLI configuration from a base station; and
the at least one CLI resource comprises a resource allocated by the base station for an uplink transmission by the second UE or a third UE to the base station.

33. The first user equipment of claim 32, wherein the processor and the memory are further configured to:
determine that the first UE cannot communicate with the base station via an uplink channel;
transmit the CLI measurement report via a sidelink channel to the second UE after determining that the first UE cannot communicate with the base station via the uplink channel.

34. The first user equipment of claim 30, wherein the processor and the memory are further configured to:
receive the CLI configuration from the second UE.

35. The first user equipment of claim 30, wherein the processor and the memory are further configured to:
receive the CLI configuration via a sidelink channel from the second UE.

36. The first user equipment of claim 30, wherein the CLI configuration indicates that the first UE is to send the CLI measurement report to a base station.

37. The first user equipment of claim 30, wherein the CLI configuration indicates that the first UE is to send the CLI measurement report to the second UE.

38. The first user equipment of claim 30, wherein the CLI configuration indicates that the at least one CLI resource is an uplink resource or a sidelink resource.

39-72. (canceled)

73. A first user equipment (UE), comprising:
a transceiver;
a memory; and
a processor communicatively coupled to the transceiver and the memory, wherein the processor and the memory are configured to:
receive a message from a base station via the transceiver, wherein the message configures the first UE to schedule cross link interference (CLI) measurements;
generate a first CLI configuration for a second UE after receiving the message;
transmit the first CLI configuration to the second UE; and
receive a CLI measurement report from the second UE after transmitting the first CLI configuration to the second UE.

74. The first user equipment of claim 73, wherein the processor and the memory are further configured to:
transmit the first CLI configuration via a sidelink channel to the second UE; and
receive the CLI measurement report via the sidelink channel from the second UE.

75. The first user equipment of claim 73, wherein the processor and the memory are further configured to:
receive a second CLI configuration from the base station, wherein the second CLI configuration specifies at least one CLI resource for the first UE to measure;
select a first resource of the at least one CLI resource for the second UE to measure and including an indication of the first resource in the first CLI configuration.

76. The first user equipment of claim 75, wherein the at least one CLI resource comprises a resource allocated to a third UE for an uplink transmission to the base station.

77. The first user equipment of claim 73, wherein the processor and the memory are further configured to:
select a sidelink resource for the second UE to measure; and
include an indication of the sidelink resource in the first CLI configuration.

78. The first user equipment of claim 77, wherein the sidelink resource comprises a resource allocated to a third UE for a sidelink transmission.

79. The first user equipment of claim 73, wherein the processor and the memory are further configured to:
identify interference on a first set of resources of a plurality of resources;
select a sidelink resource for the second UE to measure from a second set of resources of the plurality of resources, wherein the second set of resources is different from the first set of resources; and
include an indication of the sidelink resource in the first CLI configuration.

80. The first user equipment of claim 73, wherein the processor and the memory are further configured to:
extract CLI signal measurement information from the CLI measurement report; and
calculate a level of CLI at the second UE from the CLI signal measurement information.

81. The first user equipment of claim 73, wherein the processor and the memory are further configured to:
extract CLI signal measurement information from the CLI measurement report; and
calculate UE position information from the CLI signal measurement information.

82. The first user equipment of claim 73, wherein the processor and the memory are further configured to:
elect to use the CLI measurements to determine UE positioning;
select a sidelink resource for the second UE to measure after electing to use the CLI measurements to determine UE positioning.

83. The first user equipment of claim 73, wherein the processor and the memory are further configured to:
determine that a Uu CLI resource is not currently configured; and
elect to use a sidelink resource for the CLI measurements after determining that the Uu CLI resource is not currently configured.

84. The first user equipment of claim 73, wherein the processor and the memory are further configured to:
determine that Uu CLI resources are to be used for the CLI measurements;
select a Uu resource for the second UE to measure after determining that Uu CLI resources are to be used for the CLI measurements.

85-106. (canceled)
